(19) United States
(12) Patent Application Publication
(10) Pub. No.: US 2014/0100960 A1
(43) Pub. Date: Apr. 10, 2014

(54) System and Method for Programmatically Creating Local Business Advertisements Suitable for Display on Mobile Devices and Applications Thereof

(71) Applicant: Jing Ning, Herndon, VA (US)

(72) Inventor: Jing Ning, Herndon, VA (US)

(21) Appl. No.: 14/051,434

(22) Filed: Oct. 10, 2013

Related U.S. Application Data
(60) Provisional application No. 61/712,194, filed on Oct. 10, 2012.

(51) Int. Cl. G06Q 30/02

(52) U.S. Cl. CPC G06Q 30/0261
USPC 705/14.58

(57) ABSTRACT

A system and method is provided for programmatically creating advertisements effective and suitable for display on a small display screen of a mobile device. The system comprises means for programmatically acquiring advertisement data of a local business, which may include acquiring the advertisement data through accessing a third party data aggregator using open APIs thereof. The system further comprises means for receiving real-time location information of the mobile device. The system further comprises means for programmatically creating a banner ad based on the acquired advertisement data and the received real-time location information of the mobile device. The system may further means for programmatically creating a display ad. The created banner ad or display ad displays information identifying or promoting the local business as well as information indicating location of the local business relative to the real-time location information of the mobile device.

### CROSS-REFERENCE TO RELATED APPLICATION

This application claims the benefit under 35 U.S.C. §119(e) of Provisional Patent Application No. 61/712,194, filed Oct. 10, 2012, the entire disclosure of which is hereby incorporated by reference.

### BACKGROUND

1. Technical Field

The present disclosure generally relates to a system and method for creating local advertisements for mobile devices. The present disclosure more particularly relates to a system and method for programmatically creating local business advertisements suitable for display on mobile devices, as well as applications thereof.

2. Description of the Related Art

As technology advances, networking-capable wireless mobile devices, such as smart phones, tablets, and PDAs, have become more and more affordable and available to ordinary users. Increasingly, more and more of those mobile devices are equipped with GPS. Via a host mobile device's wireless networking capability, GPS can provide real-time location information about the host mobile device (and thus location information about the user of the host mobile device) to a Content Provider (e.g. a popular web site, a provider of a popular mobile application such as a mobile game, or the provider of the underlying operating system of the host mobile device) as the user accesses the Content Provider with the user's mobile device. The user's access gives the Content Provider opportunities to display revenue-generating advertisements on the user's mobile device as a consideration for allowing the user to enjoy or otherwise access the content or service provided by the Content Provider.

Having received the user's real-time location information, one option of the content-provider is displaying advertisements of local businesses in close proximity to the user's real-time location. This in turn creates a demand of the Content Provider for supplies of paid location-aware advertisements for local businesses on advertising slots created as a result of volumes of users' accesses of the Content Provider via their respective mobile devices. There are hundreds of thousands of different types of Content Providers creating display opportunities for location-aware advertisements on mobile devices. Thus, the demand for supplies of such paid advertisements for local businesses on hundreds of millions of diversely located mobile devices can be immense. This demand should continue to increase, as more and more users choose to use mobile devices to access various contents.

Meeting this increasing demand for supplies of paid location-aware local business advertisements is an enormous challenge. To Applicant's knowledge, there is at least one major bottleneck for meeting the demand. Briefly, conventional online advertising systems do not have available an effective solution which makes it substantially hassle-free for local small businesses to create their own advertisements specifically suitable and effective for being placed on location-aware hand-held mobile devices as respective users of the mobile devices are accessing various contents provided by Content Providers.

As a first issue, conventional online advertising systems indiscriminately require potential advertisers including local small businesses—who are often either not savvy in computers or lacking necessary man power or initiative to sit through a non-trivial process required for creating their own advertisements—to expend non-trivial manual intervention and effort in order to have their own advertisements can be created.

As a second issue, conventional online advertising systems, although allowing various businesses (including local small businesses) to create their own advertisements, such created advertisements are not specifically designed to be placed on a hand-held mobile device (e.g. a hand-held smart phone such as iPhone or Samsung Galaxy phone) of a small screen size along with an on-going contemporaneous display of content provided by a Content Provider. In particular, such created advertisements are more suitable for being placed on a web page displayed on a conventional PC or laptop having a display screen having a real estate space several times larger than, e.g. the real estate space of the display screen of an iPhone or Samsung Galaxy phone.

As a third issue, an advertisement created by conventional online advertising systems for a local business invariably lacks content dynamically created using available real-time location information of a target location-aware mobile device and informing the user (of the target mobile device) of the exact real-time proximity of the local business to the user. The absence of such dynamic content is particularly acute when the user is in close proximity to the local business while searching for nearby businesses to patronize, but ends up not patronizing the local business (despite that an advertisement of the local business is displayed the target mobile device) simply because the user has no clear idea from the displayed advertisement as to exactly how far the local business is from the user's real-time location.

The advertising system disclosed in U.S. Patent Application Publication No. 2010/0125496 to Wong (hereinafter referred to as “the '496 application”) demonstrate the above-listed three issues of the conventional online advertising platforms. Briefly, the advertising system of the '496 application (hereinafter referred to as “the '496 advertising system”), in creating an advertisement for a local business, first searches against various external databases for information relating to the local business, and subsequently requires a human representative for the local business (e.g., the local business owner or manager) to repeatedly either confirm or filter the search results one piece at a time for contents relating to the local business.

As demonstrative of the first conventional issue in connection with the '496 system, if the search results include a non-trivial number of customer reviews, the human operator (for the local business) may need to spend a non-trivial amount of time and effort to manually review and act on each of the customer reviews in order to complete the confirmation or filtering procedure. Understandably, for the '496 scheme, this confirmation or filtering procedure is inevitable. Specifically, the searches are performed against various external databases and thus may likely return search results (contents) inapplicable or unrelated to the local business. If the confirmation or filtering procedure were omitted, an ensuing advertisement may end up incorporating contents inapplicable or unrelated to the local business. Thus, as to the '496 ad creation scheme, non-trivial human intervention and effort are usually required.

As demonstrative of the second conventional issue in connection with the '496 system, after the human (for the local business) completes the confirmation or filtering procedure, an advertisement created using the confirmed or filtered contents, as shown in FIG. 9 of the '496 application, is only suitable for being placed on a web page displayed on a PC or laptop screen. Although the '496 application generally mentions that other advertisements may be created for different sizes and formats, the '496 system, like other conventional online advertising systems, provides no concrete solution as to creating advertisements specifically designed and tailored to be placed on the small display screen of a hand-held mobile device (e.g. a hand-held smart phone such as iPhone or Samsung Galaxy phone) together with an on-going contemporaneous display of content provided by a Content Provider, in such a manner that would achieve effective and optimal advertising results.

As demonstrative of the third conventional issue in connection with the '496 system, a created advertisement (if displayed on a target mobile device), as clearly shown in FIG. 9 of the '496 application, simply does not have any content dynamically created using, e.g., available real-time location of the target mobile device and informing the user (of the target mobile device) of the exact real-time proximity of the local business to the user.

Thus, as a major bottleneck, conventional online advertising systems simply do not have available an effective solution which makes it substantially hassle-free for local small businesses to create their own advertisements specifically suitable and effective for being placed on the respective small display screens of hand-held location-aware mobile devices as respective users of the mobile devices are accessing contents provided by various Content Providers. Therefore, there is a need for a system and method that can address this major bottleneck of conventional online advertising systems so as to provide an effective solution for local small businesses to take advantage of advertising on location-aware mobile devices and in the meantime meet the increasing demand of various Content Providers for supplies of paid local business advertisements designated to be placed on location-aware mobile devices.

### BRIEF SUMMARY

In one aspect, the present disclosure provides a system and method of programmatically creating advertisements for a local business specifically tailored for display and use on mobile devices using information or image data for the local business either collected from the local business (e.g. through a sign-up procedure) or already available in a data-aggregator system.

In another aspect, the present disclosure provides a system and method of programmatically creating a dynamic advertisement containing real-time information relating to a target mobile device (otherwise unavailable in conventional mobile advertisements) contemporaneously before the dynamic advertisement is being delivered on demand to an ad consumer for real-time display on the target mobile device.

In yet another aspect, the present disclosure provides an advertisement supplier system and method of signing-up local businesses affiliated with one or more data aggregators and supplying advertisements (for participating local businesses) suitable for display on mobile devices without requiring a participating local business to spend a non-trivial amount of time and manual effort (as otherwise required by conventional online advertising systems) to create its own such advertisements.

In yet another aspect, the disclosed ad creation system and method may include advertising display or delivery means specifically tailored to achieve effective advertising on a small display screen of a mobile device. Specifically, in one embodiment, a “one-two-punch” of a package of a banner ad and a display ad for a local business is provided. The much-smaller-in-size banner ad is designed to be displayed together with the main content on the small display screen, with the banner ad only occupying a small portion of the small display screen and serving as a lead to attract the user's attention to the local business (with its contents compactly organized and specifically tailored to attract the user's attention). As a user of the mobile device clicks or taps the displayed banner ad, the display ad is then displayed to occupy all or a big portion of the small display screen, with the display ad displaying much more detailed information about the local business. Additionally, a unified deliverable entity for rendering both the banner ad and the display ad is created to facilitate and realize the efficiency delivery of both the banner ad and the display ad.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements may be exaggerated relative to other elements. Embodiments incorporating teachings of the present disclosure are shown and described with respect to the figures presented herein, in which:

FIGS. 1A-C are general diagrams illustrating an exemplary operating environment of the disclosed system and method from different perspectives, according to one or more embodiments of the present disclosure.

FIG. 2 is a block diagram illustrating an exemplary ad supplier system, according to one or more embodiments of the present disclosure.

FIGS. 3A-B are pictorials illustrating an exemplary banner ad for a local business as well as an exemplary accompanying display ad for the same local business, both of which are programmatically created and specifically tailored for display and use on a location-aware mobile device, according to one or more embodiments of the present disclosure.

FIGS. 4A-B are flow and block diagrams illustrating programmatic blocks used to create a banner ad and/or a display ad for a local business, according to one or more embodiments of the present disclosure.

FIGS. 5A-C are a diagram and two pictorials collectively illustrating a first type of advertisement data acquisition scheme as implemented by an Ad Creator module, according to one or more embodiment of the present disclosure.

FIGS. 6A-B are diagrams illustrating a second type of advertisement data acquisition scheme as implemented by an Ad Creator module, according to one or more embodiment of the present disclosure.

FIGS. 7A-C are a diagram and two pictorials collectively illustrating a third type of advertisement data acquisition scheme as implemented by an Ad Creator module, according to one or more embodiment of the present disclosure.

FIG. 8 is a flowchart illustrating an exemplary implementation of block 402—namely, programmatically creating a banner ad and/or a display ad for a local business—according to one or more embodiments of the present disclosure.

FIGS. 9A-D are a flowchart, pictorials and a code snippet collectively illustrating an exemplary implementation of block 801—namely, programmatically creating a foundation entity for a banner ad—according to one or more embodiments of the present disclosure.

FIGS. 10A-E are a flowchart, a pictorial and code snippets collectively illustrating an exemplary implementation of block 802—namely, programmatically creating a foundation entity for a display ad—according to one or more embodiments of the present disclosure.

FIG. 11 is a flowchart illustrating an exemplary implementation of block 803—namely, programmatically creating deliverable entity or entities for the banner ad and/or the display ad—according to one or more embodiments of the present disclosure.

FIG. 12 is a flowchart illustrating a scheme in which an Ad Supplier system (which incorporates the ad creation system and method illustrated in FIGS. 3-11) uses to supply mobile advertisements for local businesses, according to one or more embodiments of the present disclosure.

FIG. 13 is a block diagram illustrating an Ad Supplier system configured to supply mobile advertisements for local businesses to a location-aware target mobile device, according to one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof. Also, descriptions of well-known functions and constructions are omitted for clarity and conciseness.

References within the specification to “one embodiment,” “an embodiment,” “embodiments”, and “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed according to a specific sequence, are presumed to be performable in any order without regard to a specific sequence.

Within the descriptions of the different views of the figures, the use of the same reference numerals and/or symbols in different drawings indicates identical, similar, or close related items, and similar or closely related elements can be provided similar names, reference numerals, and reference alpha-numerals throughout the figures. If a reference numeral is once used to refer to a plurality of like elements, unless required otherwise by context, the reference numeral may refer to any, a subset of, or all of, the like elements in the figures bearing that reference numeral. A reference alpha-numeral (such as “326A”) may refer to one implementation or one portion of one element or a plurality of like elements bearing the same base reference numeral (such as “326”). The specific identifiers/names, reference numerals and reference alpha-numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows or requires, may be used interchangeably to refer to one or more sets of computer instructions adapted to perform, when executed by a processor (such as a microprocessor or a microcontroller), one or more specific functions.

As used herein, the terms “ad”, “ads”, “advertisement” and “advertisements”, so long as allowed by the context, may be used interchangeably to refer to one or more advertisements, one or more concrete forms of one or more advertisements (such as one or more deliverable and renderable entities for one or more advertisements), and any combination thereof.

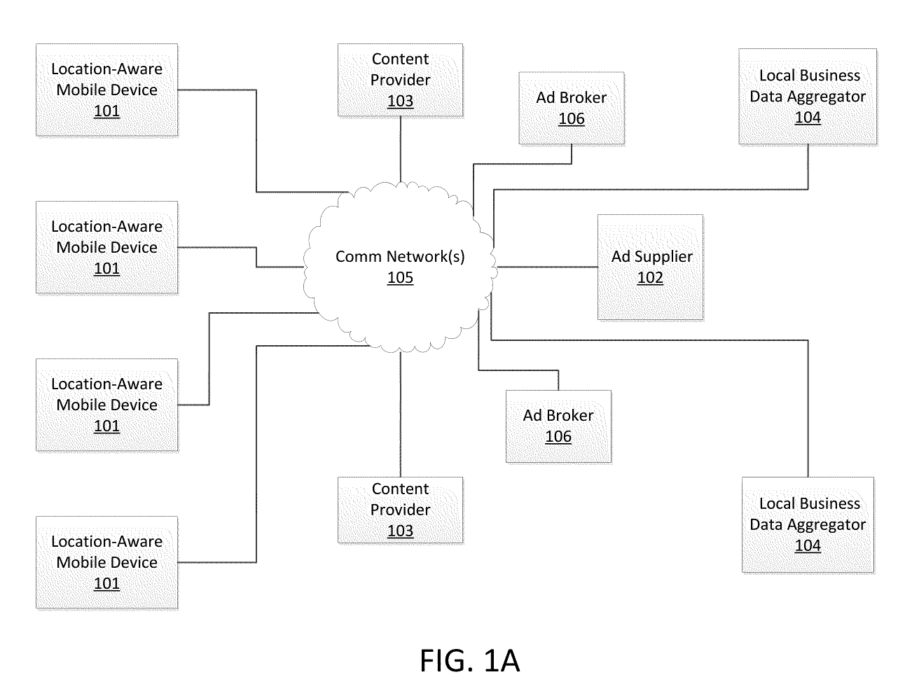

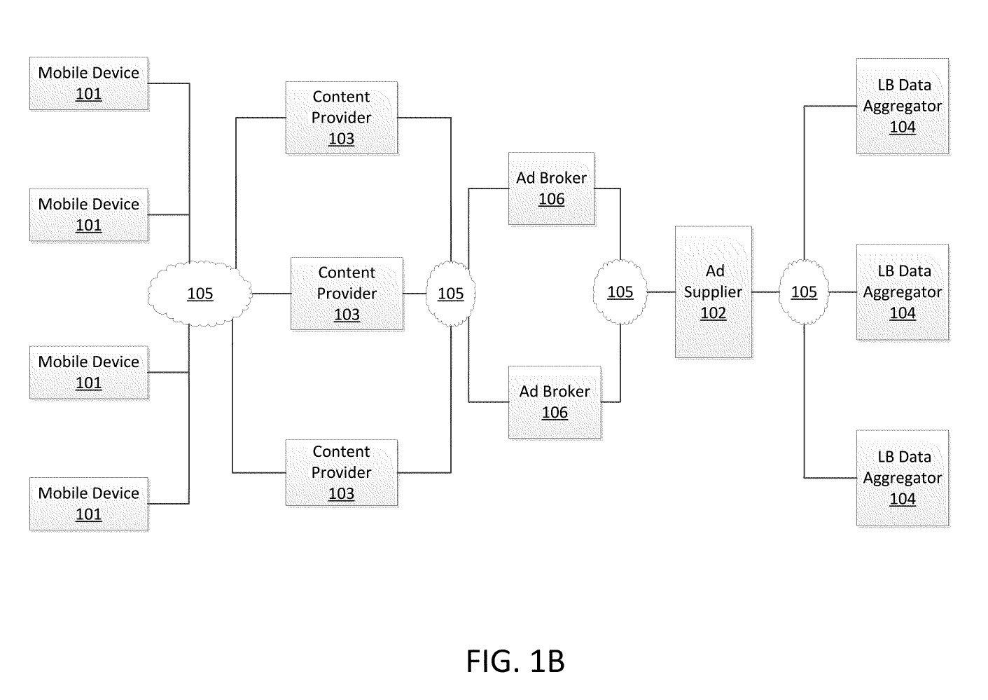

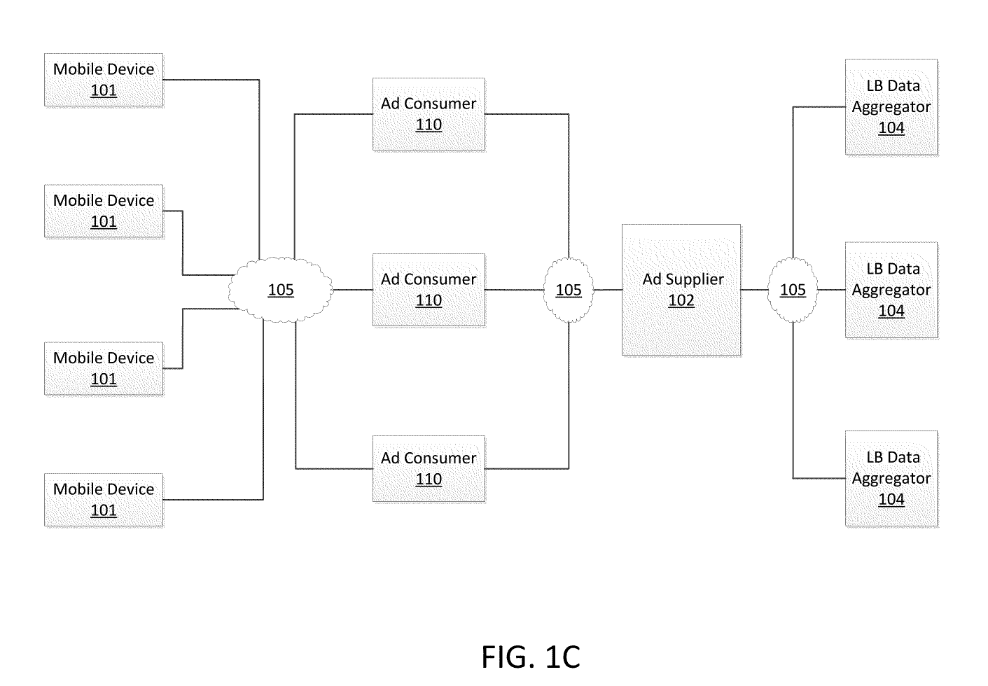

With reference now to the figures, and beginning with FIGS. 1A-C, there are depicted general diagrams illustrating an exemplary operating environment of the disclosed system and method from different perspectives, according to one or more embodiments of the present disclosure.

Referring to FIG. 1A, which is a block diagram illustrating an exemplary operating environment of the disclosed system and method from a network topology perspective, the operating environment of the disclosed ad creation system and method may comprise an Ad Supplier system 102, one or more Ad Broker systems 106, a plurality of Content Provider systems 103, a plurality of local business Data Aggregator systems 104, and a plurality of location-aware mobile devices 101. Each of Ad Supplier system 102, Ad Broker systems 106, Content Provider systems 103, local business data aggregator systems 104 and mobile devices 101 may be communicatively coupled to each other through one or more communication networks 105, which may include Internet and/or one or more interconnected networks, such as one or more cellular networks, one or more dedicated networks, and/or one or more local area networks.

As used herein, the terms “Ad Supplier” and “Ad Supplier system” may be used interchangeably to refer to an online advertisement creation, aggregate and supply system which supplies local business advertisements specifically created for display on target location-ware mobile devices 101 to, e.g. an Ad Broker or a Content Provider using the disclosed local advertisement creation system and method.

As used herein, the terms “Content Provider” and “Content Provider system” may be used interchangeably to refer to an online system which provides content to a plurality of location-aware mobile devices 101 for respective users of location-aware mobile devices 101 to enjoy or consume the provided content. The term “content” must be construed broadly to include any type of content which a user of a location-aware mobile device 101 can enjoy or consume. Examples of content may include various web pages which a user can view, various software programs (such as games and other programs) which a user can play or view, various videos or still images which a user can watch, and the underlying operating system of a location-aware mobile device 101. Thus, the term “Content Provider” must also be broadly construed to include any online system that can provide any type of content to a plurality of location-aware mobile devices 101. Examples of a “Content Provider” may include online systems providing web sites delivering web pages to location-aware mobile devices 101, online systems providing software programs (such as games and other content-providing programs) running on location-aware mobile devices 101, and online systems providing underlying operating systems of location-aware mobile devices 101.

As used herein, the terms “local business Data Aggregator”, “local business Data Aggregator system”, “Data Aggregator” and “Data Aggregator system” may be used interchangeably to refer to an online system, collecting, aggregating and storing information or data about a plurality of local businesses in diverse geographical areas, such that the aggregated local business information or data can be viewed or otherwise accessed online via either a web site or a software application provided by the online system. Examples of a Data Aggregator 104, as applicable to the present disclosure, may include, but are not limited to, online local listing services or web sites, such as Yelp, Google Places, Yahoo!, Four Square, Groupon, Living Social, Facebook, Service Magic and Angies List. Many of these Data Aggregators encourage customers who have previously used a particular local business to leave feedbacks (which usually include ratings) thereon so as to collect feedback information and compute an overall rating thereon. The feedback information, particularly the overall rating information, on the local business may then be displayed (e.g., on a profile web page of the local business), which is intended to help a new customer to make an informed decision on whether to use the local business.

As used herein, the terms “Ad Broker” and “Ad Broker system” may be used interchangeably to refer to an online system which acts as a broker between a Content Provider system 103 which has a demand for receiving paid advertisements that can be placed on the media available to the Content Provider system and a system which supplies advertisements (such as Ad Supplier 102). Examples of Ad Brokers 106 include online advertisement agency systems and online advertisement exchange systems.

A location-aware mobile device 101 may be any portable hand-held computing device having networking capabilities, equipped with one or more devices which can acquire contemporaneous location information of the mobile device (such as a GPS receiver), and loaded with one or more client software applications enabling a user to perform various specific software functions. Examples of a location-aware mobile device 101 may include a GPS-equipped smart phone (such as an iPhone or a Samsung Galaxy small phone) or GPS-equipped PDA.

Each of location-aware mobile devices 101 typically includes one or more processors (such as a microprocessor or microcontroller), one or more system memories, one or more communication modules (such as a network interface device, an RF unit, and antenna, or any combination thereof), one or more interface modules (such as a USB connector), one or more input modules (such as a keyboard, an input pointing means (such as a mouse, a touchpad, a touch screen, or any combination thereof), input keys, or any combination thereof), one or more storage modules (such as one or more various internal and external storage media (such as RAM, ROM, hard disk, smart card, flash memory) and any external storage accessible via, e.g., a communication module or an interface module), and one or more display module (such as a display screen) which may serve as part of the input module if the display module includes a touch screen.

Specifically applicable to the present disclosure, a display screen of a location-aware mobile device 101, size-wise, is usually much smaller than, or in other words only a fraction of, a typical display screen for PCs or laptops. A non-browser application running on location-aware mobile device 101 is commonly referred to as an “app.” As used herein, the term “client application” refers to a software application running on a client device 101, which may either be a browser application or a non-browser app.

FIG. 1B is a block diagram illustrating an exemplary operating environment of the disclosed system and method from a control flow perspective. In one embodiment, a location-aware mobile device 101, in acquiring desired contents, communicates with one or more Content Providers 103. In particular, a location-aware mobile device 101 may end up sending its contemporaneous location information to one or more Content Providers 103 via, e.g., one or more apps provided by one or more Content Providers 103 for accessing contents thereof.

A Content Provider 103, in placing an advertisement for a local business local to the contemporaneous location of a target location-aware mobile device 101, communicates with one or more Ad Brokers 106 so as to receive one or more deliverable and renderable entities for such a local business advertisement. In particular, a Content Provider 103 may communicate the contemporaneous location information of a target mobile device 101 (which the Content Provider receives from the target mobile device 101) to one or more Ad Brokers 106.

An Ad Broker 106, in supplying deliverable and renderable entities for local business advertisements to one or more Content Providers, requesting Ad Supplier 102 for, and receiving from Ad Supplier 102, deliverable and renderable entities for local business advertisements. In particular, an Ad Broker 106 may communicate the contemporaneous location information of a target mobile device 101 (which the Ad Broker 106 receives from a Content Provider 103) to Ad Supplier 102.

In one implementation, Ad Supplier 102, in supplying deliverable and renderable entities (for local business advertisements) to one or more Ad Brokers 106, dynamically creates each of such deliverable and renderable entities (for local business advertisements) based on the received contemporaneous location information of a target mobile device 101. In particular, each of such deliverable and renderable entities (for local business advertisements) is specifically created for effective and meaningful display and use on the small screen of a target mobile device 101. In acquiring advertisement data needed for creating such deliverable and renderable entities for local business advertisements, Ad Supplier 102 may communicate with one or more Data Aggregators 104 so as to receive local business information or data therefrom.

FIG. 1C is a block diagram illustrating an exemplary operating environment of the disclosed system and method not only from a control flow perspective but also from a specific functional perspective. As shown, compared to FIG. 1B, Content Providers 103 and Ad Brokers 106 are replaced by Ad Consumers 110. Specifically, from the standpoint of Ad Supplier 102, Content Providers 103 and Ad Brokers 106 make no difference to Ad Supplier 102, given that they all “consume” local business advertisements (provided in the form of deliverable and renderable entities) supplied by Ad Supplier 102. Thus, to Ad Supplier 102, Content Providers 103 and Ad Brokers 106 are both Ad Consumers 110.

Hence, as used herein, the term “Ad Consumer” refers to an online system or a group of online systems (other than any target location-aware mobile device 101) directly or indirectly receiving local business advertisements supplied by Ad Supplier 102 for the purpose of ultimately placing the received local business advertisements on a target location-aware mobile device 101 to engage in mobile advertising, regardless of where and how the online system or the group of online systems is/are upstream or downstream to Ad Supplier 102. Examples of an Ad Consumer 110 include any Content Provider 103 and any Ad Broker 106.

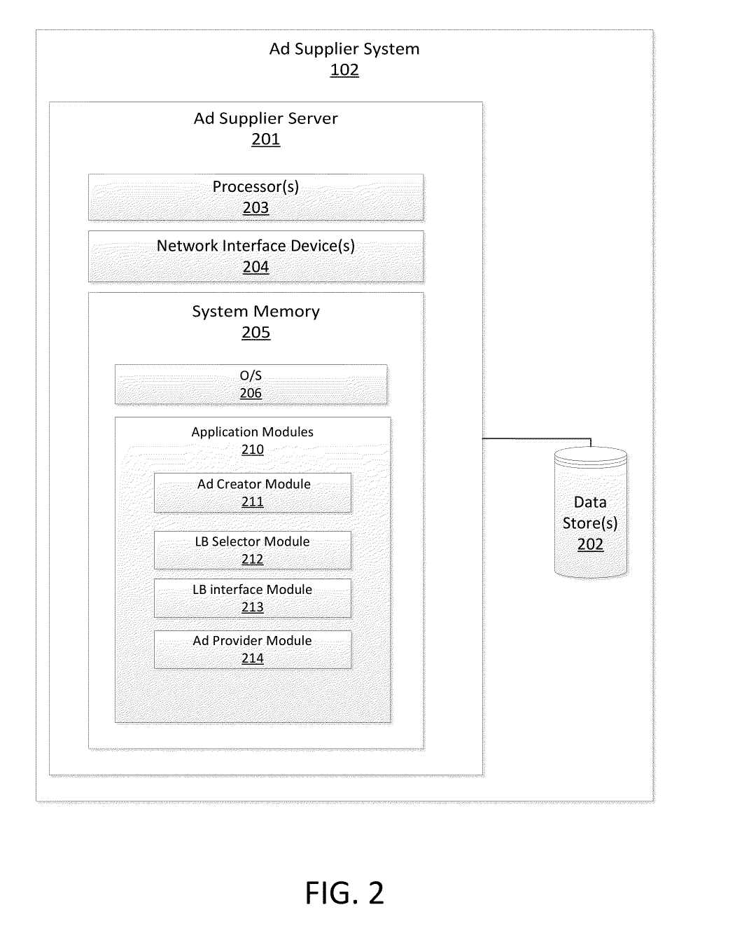

FIG. 2 is a block diagram illustrating an Ad Supplier system, according to one or more embodiments of the present disclosure. Referring to FIG. 2, Ad Supplier system 102 may comprise server 201 and data store 202. As used herein, the term “server” refers to any of various types of computing devices, such as computer clusters, server pools, general-purpose personal computers, workstations, or laptops. Server 201 comprises, inter alia, one or more processors 203 (such as one or more microprocessors), one or more network interface devices 204, and one or more system memories 205. During an operation of server 201, software modules or firmware modules, such as operating system 206 and a plurality of application modules 210, are loaded into system memories 205. These software or firmware modules, when executed by one or more processors 203, are adapted to perform various functions for which their respective programmatic (software) codes are programmed.

Data store 202 (hereinafter referred to as “DS 202”) is communicatively coupled to server 201. DS 202 may exist or be implemented in one or more of various forms, such as one or more local or distributed relational or objective databases, one or more local or distributed file systems, one or more removable storages, one or more memory caches, one or more memory clusters, or any combination thereof. In one embodiment, DS 202 resides in server 201. In another embodiment, DS 202 resides external to server 201. DS 202 may be configured to store data needed for Ad Supplier 102 to create, aggregate and supply mobile advertisements for local businesses, as will be disclosed in more details below.

Application modules 210 may be implemented in various forms, such as standalone executable programs, callable functions and routines, scripts that can be executed via running of one or more interpreter programs, services that may be invoked by standard or proprietary protocols, and programmatic objects containing both data and callable functions. In one embodiment, application modules 210 may include an Ad Creator module 211, a local business (“LB”) selector module 212, a local business interface module 213 and an Ad Provider module 214.

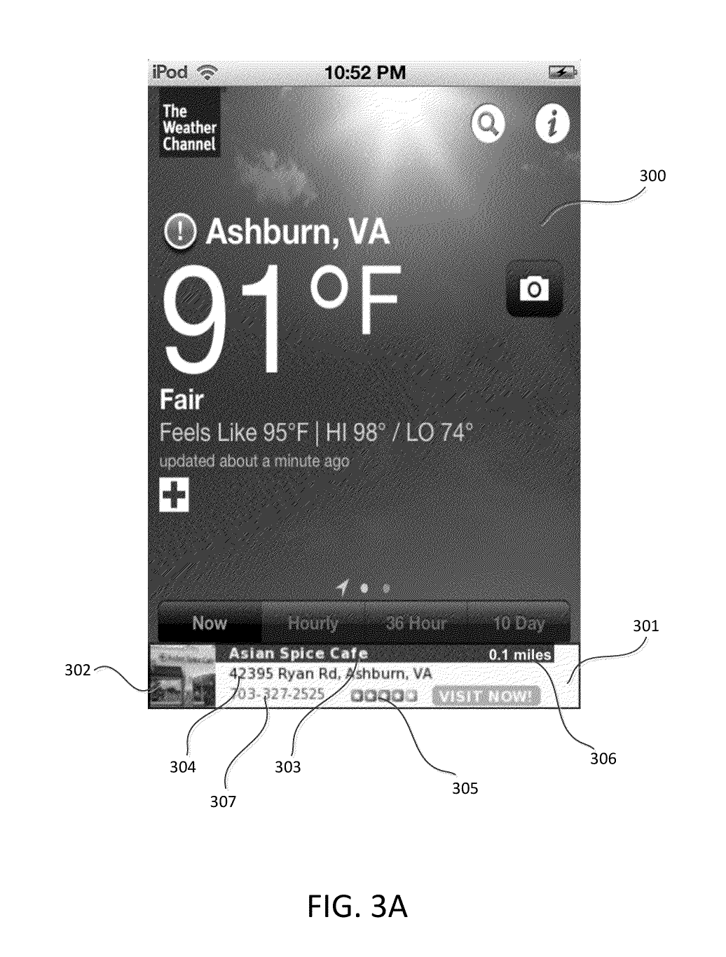

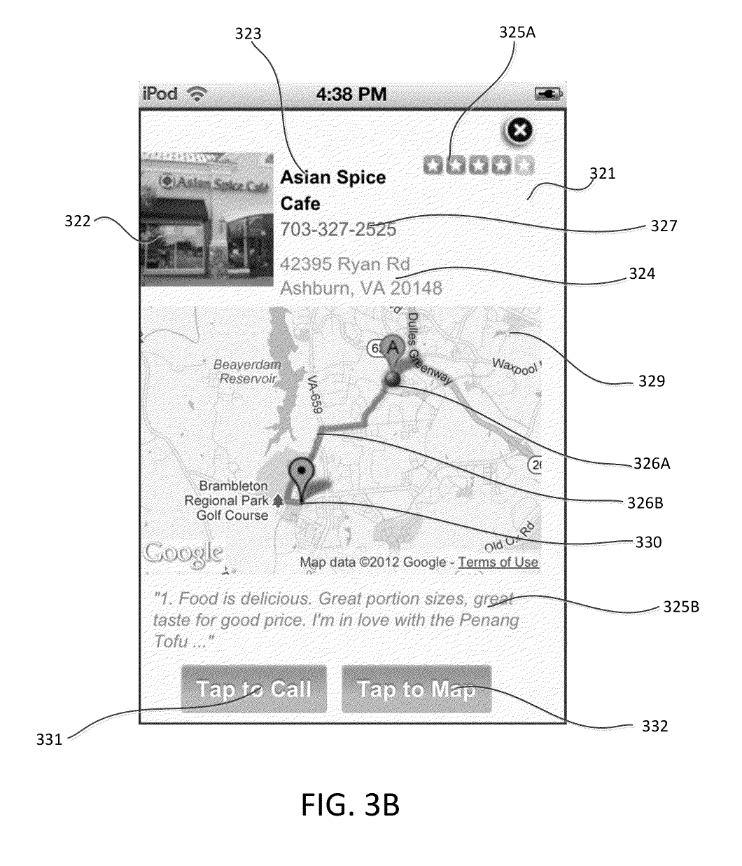

FIGS. 3A and 3B illustrate an exemplary banner advertisement (referred to hereinafter as “banner ad”) as well as an exemplary expanded display advertisement (referred to hereinafter as “display ad”) for a local business, which are programmatically created for display on location-aware mobile devices (referred to hereinafter as “mobile display”) using data either collected from the local business (through e.g. a sign-up procedure) or already available in a data-aggregator system, according to one or more embodiments of the present disclosure.

As used herein, the term “banner ad”, which may suggest inclusion of one or more images, refers to an actual advertisement placed by an Ad Consumer and displayed concurrently with a main content in a pre-allocated area on a display screen of a target mobile device, regardless of whether the advertisement contains one or more images or contains only pure text without any image. In particular, by way of example and not limitation, a banner ad may be displayed in any area of the display screen of the target mobile device, such as in a bottom area of the display screen below or overlay the main content, in a top area of the display screen above or overlay the main content, in a side area of the display screen on one side of the main content, or in a middle area of the display screen in between portions of the main content.

Also, as used herein, terms such as “image” or “images” refer to one or more still images, one or more animations, one or more videos, any audio played during display thereof, or any combination thereof.

By way of example and not limitation, information that is used for the creation of the banner ad or the display ad for a local business may include, but is not limited to, a name of the local business, an address thereof, a phone number thereof, an official web site thereof (if there is any) and up-to-date customer feedback information thereon (which may include an overall rating). Additionally, image data for the local business may also be used for the creation of the banner ad or the display ad. The image data may include one or more still images or videos showing the premises of the local business. The image data may alternatively or additionally include still images or videos made to promote the local business.

Referring to the display screen of a mobile device 101 (referred to hereinafter as “mobile display screen”) illustrated on the left side of FIG. 3A, the exemplary banner ad 301 is situated below a main content 300 that a user may be viewing, a location which is at a bottom area of the mobile display screen. Size-wise, the banner ad 301 is of a size that fits in the bottom area, which may be reserved by the Content Provider for advertisement display according to a standard size pre-defined for advertisements on mobile devices (hereinafter referred to as “mobile advertisements” or “mobile advertising”). Content-wise, the banner ad 301 displays local business information that allows a customer, such as a user of the target mobile device 101, to get an impression on, or to find, the local business. Alternately or additionally, the banner ad may further display image(s) and/or information intended to promote, or make conspicuous of, the local business—such as image(s) or information about one or more deals or offers (such as “buy one get one free” or “50% off original price”) and/or real-time distance from the target mobile device 101 to the location of the local business—which are designed to attract the user's attention and stimulate the user's interest to patronize the local business.

By way of example and not limitation, the banner ad may display name 303, address 304 and phone number 307 of the local business. The banner ad may additionally display one or more scaled images 302 depicting or promoting the local business, or summary customer feedback information 305, such as visual image 305 indicating a usually positive overall customer rating on the local business.

Additionally, the banner ad may also display information 306 indicating the real-time location of the target mobile device relative to the location of the local business, such as the distance from the real-time contemporaneous location of the target mobile device 101 to the location of the premises of the local business. To Applicant's knowledge, conventional advertisements displayed on TV, on a full-size web page of a Content Provider, or on a mobile device, are uniformly pre-made static images or videos without business-promoting information dynamically created using real-time (contemporaneous) information of the advertisement recipient such as target mobile device 101. Thus, in the context of on-demand advertising displayed on the medium or media available to a Content Provider (such as one or more areas of the mobile display screen), a banner ad displaying real-time information has a clear advantage over those conventional pre-made static advertisements, in that the banner ad displays real-time information (such as the aforementioned real-time distance information) that may influence a user's decision-making with respect to whether to patronize the local business (e.g. based on the aforementioned distance information) while conventional pre-made advertisements cannot possibly display such decision-influencing real-time information.

As demonstrated above, the exemplary banner ad is created to compactly and orderly display adequate information and image served to inform about or promote the local business while fitting in the limited space (slot) on the mobile display screen pre-allocated for advertisement display together with a primary content. Thus, the exemplary banner ad is tailored for display simultaneously with a primary content on the mobile display screen.

Referring to the mobile display screen illustrated on FIG. 3B, in one embodiment, the clicking or tapping of the banner ad leads to the displaying of a typically much-bigger display ad 321 on the mobile display screen in areas previously occupied by the banner ad and part or all of the main content 300. Thus, the display ad displays additional information and/or more detailed information with respect to the local business not otherwise displayable within the limited area allocated for the banner ad.

As used herein, terms such as “click”, “clicking”, “tap” or “tapping” refer to any contemporaneous user action performed on a user interface (UI) element, action which may be, but is not limited to, clicking, tapping, swiping, sliding, dragging, pinching, shaking, double-clicking, or any combination thereof, that causes a response reacting to such an action from a target mobile device 101.

By way of example and not limitation, as illustrated, an image 322 showing the premises of the local business as included in the exemplary display ad 321 may be a scaled image larger than the scaled image 302 displayed on the banner ad. The display ad may display a customized map 329 providing visual indications as to the location of the local business relative to the real-time location of the target mobile device. For example, as illustrated, the customized map 329 may include a first visual mark 326A indicating the real-time location of the target mobile device and a second visual mark 330 indicating the location of the local business. Optionally, the customized map may include a color-marked driving or walking route 326B between the real-time location of the target mobile device and the location of the local business, so as to apprise the user of a recommended route to get to the local business. Thus, the display ad 321 not only shares the same advantage (noted above) over conventional advertisements as the banner ad 301—as they both display dynamically updated real-time information that may influence the user's decision-making as to whether to patronize the local business—but amplifies that advantage by showing a customized map 329.

Besides displaying the usual name information 323, address information 324, and phone information 327 of the local business, the display ad, as afforded by the relatively bigger display space, may allow the display ad to display additional UI elements aimed to provide further convenience to the user. For example, in addition to displaying a visual customer “star” rating 325A, the display ad may further display an excerpt 325B of a customer's review on the local business, which may likewise influence the user's decision-making with respect to whether to patronize the local business. Additionally, the display ad may include two clickable or tappable buttons 331 and 332 respectively labeled “Tap to Call” and “Tap to Map”. Any of these two buttons, when clicked or tapped, provides immediate convenience to the user in terms of either calling the local business or viewing a detailed map concerning the location of the local business relative to the location of the target mobile device, either of which may increase the possibility of the user's decision to patronize the local business. Optionally, the display ad may alternately or additionally display a clickable or tappable button labeled “Go To Site”, the clicking or tapping of which may cause the target mobile device to visit an official web site of the local business, and/or a clickable or tappable button labeled “Add to Contact”, the clicking or tapping of which may cause the contact information of the local business (such as the phone number or the address of the local business), to be added to the phone book or address book of the target mobile device.

As disclosed above, the clicking or tapping of the banner ad may result in the displaying of the display ad. Thus, the banner ad is aimed to capture the user's initial attention, while the display ad is aimed to capitalize the user's initial attention (captured by the banner ad) by making a stronger pitch to the user. As a skilled artisan appreciates, there can be various ways of capitalizing the user's initial attention captured by the initially displayed banner ad. For example, the clicking or tapping of the banner ad may cause the target mobile device to visit an official web site of the local business, show a streaming promotional video about the local business via a certain URL of the local business, or directly call the local business. Thus, the display ad, or the displaying of the display ad, is optional, so long as there is one way to capitalize the user's initial attention captured by the banner ad.

The above-described scheme using both a small banner ad and a much bigger display ad (or other follow-up means), hereinafter, will be referred to a “one-two-punch” scheme. This “one-two-punch” scheme is particularly adapted to mobile advertising, and as a skilled artisan appreciates, is also very effective for mobile advertising. Since a mobile device 101 only has limited display screen “real estate”, a smaller banner ad is provided for the purpose of allowing the user to continue to access the main content while giving the user an opportunity to view a specifically tailored small-size ad for a local business wishing to catch the user's limited attention. By displaying information or image data identifying or promoting the local business as well as information or message aimed to entice or influence the user's appetite to patronize the local business (such as the real-time distance information or a promotion message), the banner add may be very effective to catch the user's initial attention or appetite directed to the local business. Once the aforementioned attention or appetite is captured by the user in the form of, e.g., the user tapping on the banner ad, the display ad serves suitably to provide more detailed information about the local business, which may effectively persuade the user to patronize the local business. Thus, as a skilled artisan appreciates, advertising in the mobile context is significantly different from advertising in, e.g. the context of a full-blown web page. As such, the aforementioned “one-two-punch” scheme, as not available in the conventional online advertising systems, is by no means automatic, but instead a culmination of inventive work and efforts.

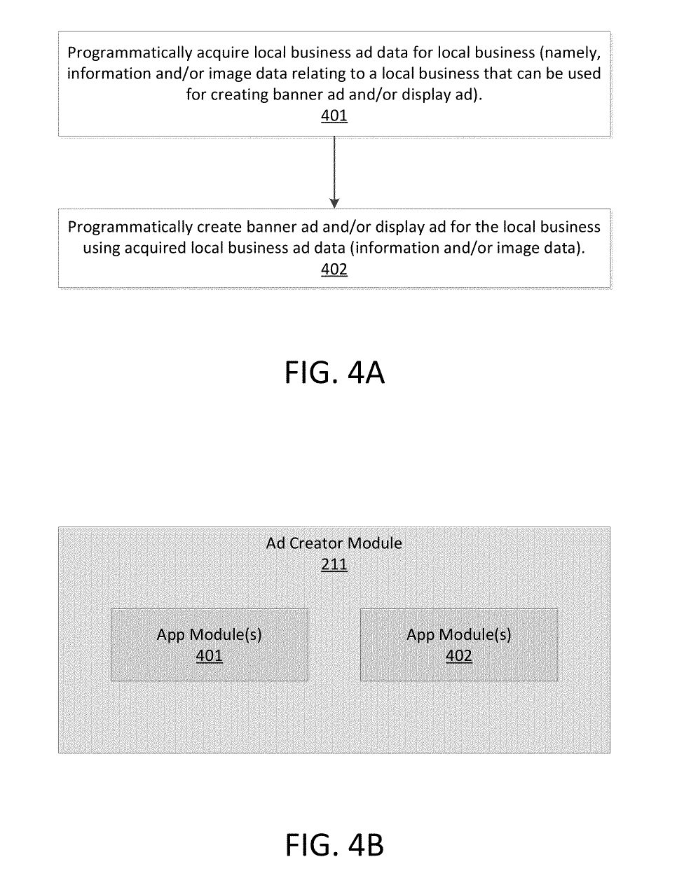

FIGS. 4A-B collectively illustrate exemplary programmatic blocks used by Ad Supplier 102 to create a banner ad and/or a display ad for a local business, according to one or more embodiments of the present disclosure.

For the purpose of illustration and not limitation, the creation of the banner ad and the display ad can be achieved by one programmatic entity or one set of programmatic entities, which will hereinafter be collectively referred to as “Ad Creator module” 211 or simply “Ad Creator” 211. As a skilled artisan appreciates, Ad Creator 211 may exist in a local environment or in a distributed environment. Specifically, Ad Creator 211 may reside across different computing machines. For example, some of the programmatic entities of Ad Creator 211 may reside in one work station, while some others may reside in another computing apparatus. Ad Creator 211 may also reside across different domains. For example, some of the programmatic entities of Ad Creator 211 may reside in one domain while some others may reside in another domain (when, e.g. different domains work in concert to programmatically create banner ads and/or display ads for mobile display).

FIG. 4A is a flowchart illustrating the aforementioned programmatic blocks. As used herein, the terms “block” and “step” may be used interchangeably to refer to a set of programmatic (software) code or instructions adapted to perform one or more specific functions (when executed by one or more processors), or the one or more performed specific functions, or any combination of.

Referring to FIG. 4A, at block 401, Ad Creator 211 programmatically acquires local business ad data—namely, information and/or image data relating to a local business that may be used to create a banner ad and/or a display ad for the local business. The acquired may include, but are not limited to, an image of the local business (or alternatively a URL where an image of the local business may be downloaded), a name of the local business, an address thereof, a phone number thereof, an official web site thereof (if there is any), and customer feedback information (which may include an overall customer rating) thereon. As part of block 401, the acquired local business ad data may be temporally or permanently stored (in DS 202) for later retrieval by another block of Ad Creator 211 (such as block 402). Alternately or additionally, as part of block 401, the acquired local business ad data may be directly passed to block 402 as, e.g., input parameters, so that block 402 can have access to the local business ad data acquired at block 401.

At block 402, Ad Creator 211 creates a banner ad and/or a display ad for the local business—which are intended to be displayed as usually paid advertisements on a target mobile device located in nearby geographical locations—using a subset or all of the local business ad data acquired in block 401 (to which, as noted above, block 402 has access).

In particular, blocks 401 and 402 do not need to be performed in a strict chronological order. For example, some sub-blocks of block 402 may be performed (executed) before some sub-blocks of block 401 are performed. Also, blocks 401 and 402 do not need to be performed within a same contemporaneous time period. More specifically, some sub-blocks of block 401 or 402 may be performed seconds, minutes, hours, days, or even months before some other sub-blocks of the same block or some sub-blocks of the other block are performed. In one implementation, with respect to a local business for which a banner ad and/or display ad are created, block 402 may be performed seconds, minutes, hours, days, or even months after some or all of sub-blocks of block 401 is performed.

FIG. 4B is a block diagram illustrating Ad Creator 2111. Ad Creator 211 may comprise application modules performing blocks 401 and 402, respectively. Thus, as shown, one or more application modules performing block 401 are correspondingly assigned the same reference numeral 401, and one or more application modules performing block 402 are correspondingly assigned the same reference numeral 402.

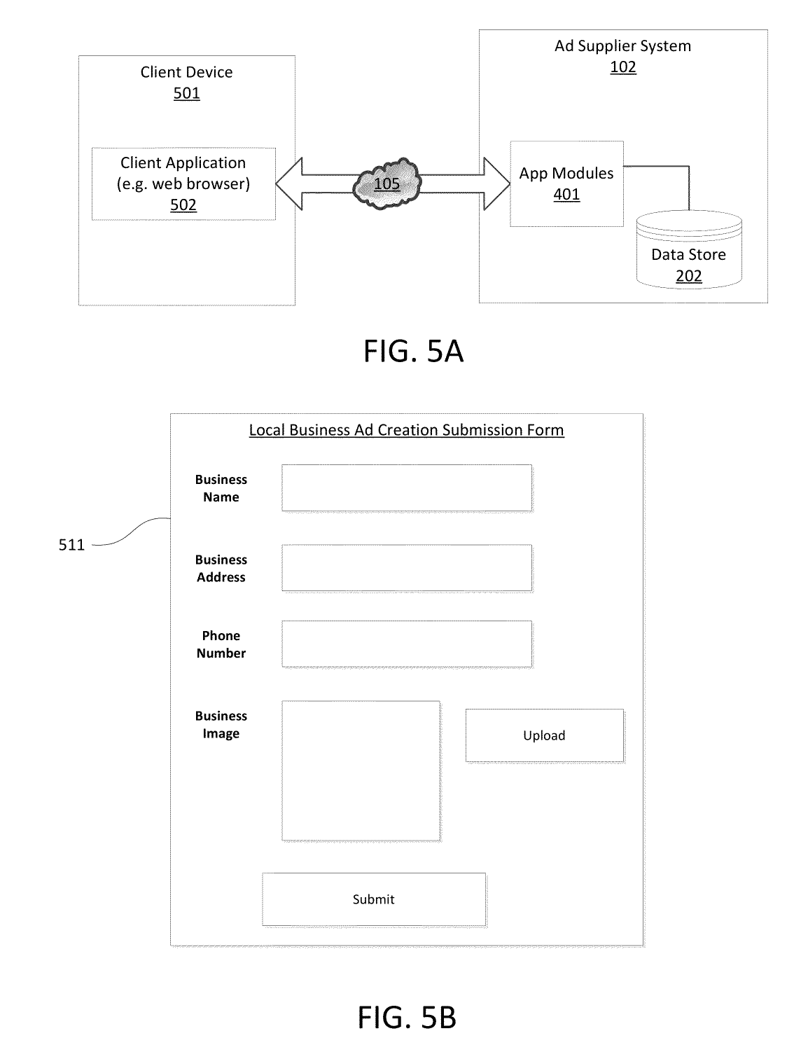

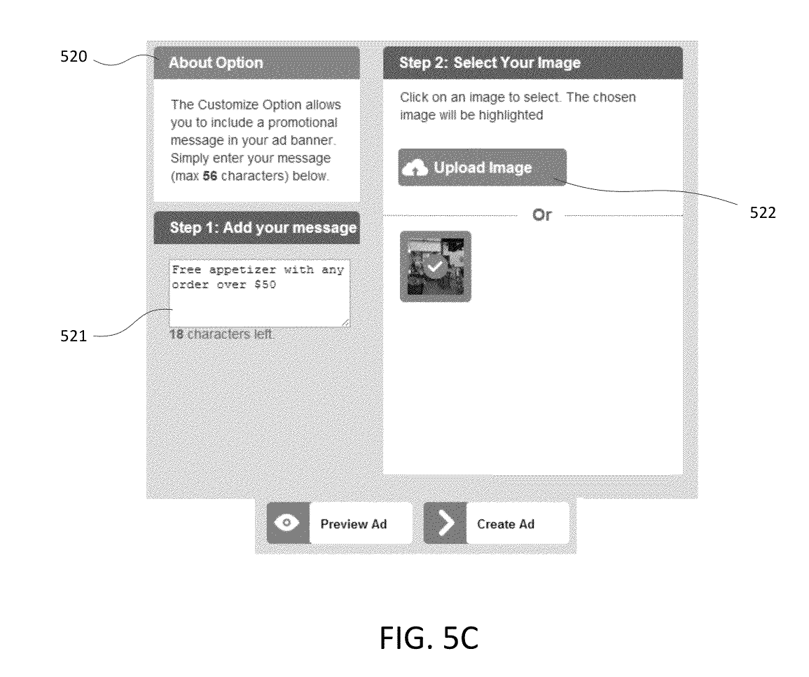

FIGS. 5A-C collectively illustrate a first type of local business ad data acquisition scheme as performed by one or more application modules 401 of Ad Creator 211, according to one or more embodiments of the present disclosure. As to this type of ad data acquisition scheme, application modules 401 directly acquire from the local business detailed information and/or desired image data thereof that can be used for programmatic creation of a banner ad and/or display ad.

Referring to FIG. 5A, which is a diagram illustrating the first type of ad data acquisition scheme, a local business may submit its information and/or image data using a client computing device 501—which may be any computing device such as a PC, a laptop, or a mobile device (e.g. a smart phone or a tablet)—through one or more client applications 502 (such as a web browser or a custom non-browser application).

Referring to FIG. 5B, which is a pictorial illustrating an exemplary submission form 511 (e.g., displayed by client application 502) provided by Ad Supplier 102 for a local business to use to submit data that can be used for programmatic creation of a banner ad and/or a display ad therefor, the local business may submit its information and/or image data via the submission form 511.

FIG. 5C is a pictorial illustrating an exemplary form 520 which may be additionally provided by Ad Supplier 102 (via client application 502) for the local business to use for submitting additional data that can be used for programmatic creation of a banner ad and/or a display ad therefor. The local business, through form 520, may submit to Ad Supplier 102 additional information, such as a promotional message 521, via an UI input box 521, or submit (upload) one or more additional images via UI button 522. Alternately or additionally, the local business may use one or more e-mails to submit one or more additional promotional messages or image data to Ad Supplier 102.

Application modules 401 are programmed and configured to acquire information and/or image data provided by the local business via e.g., a client application 502 running on a client device 501 of the local business, or e-mails sent from the local business.

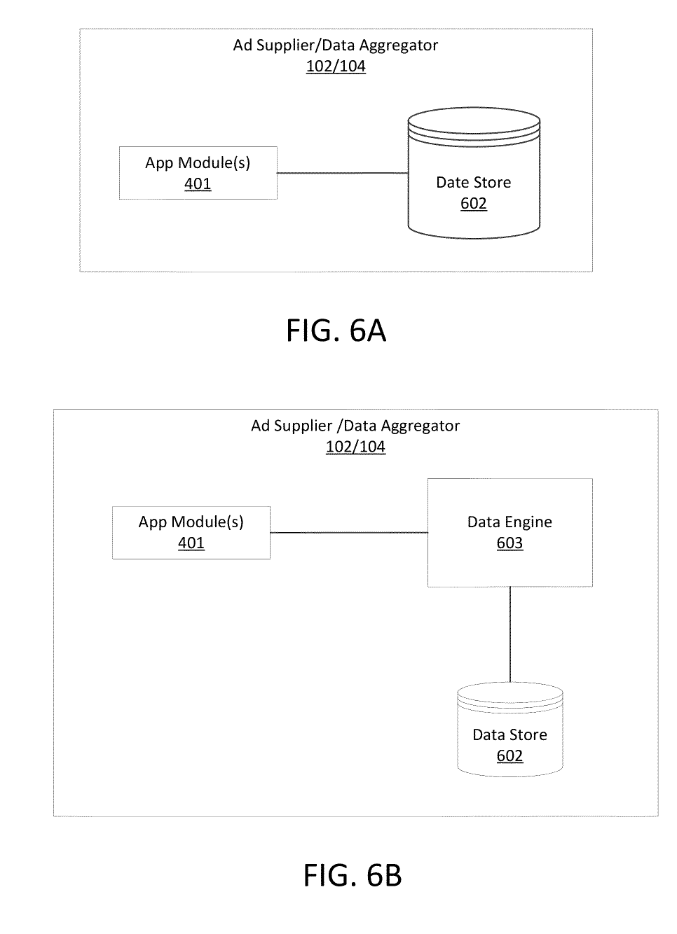

FIGS. 6A-B collectively illustrate a second type of ad data acquisition scheme as performed by one or more application modules 401 of Ad Creator 211, according to one or more embodiments of the present disclosure. As to this type of ad data acquisition scheme, referring to FIGS. 6A and 6B, each of which is a diagram illustrating an implementation of the scheme, application modules 401 are one part of an Ad Supplier system 102 which, in and by itself, is also a Data Aggregator 104.

Applicable to the present disclosure, a Data Aggregator 104 may be an Ad Supplier 102 itself, and may even be an Ad Supplier 102 as well as an Ad Consumer 110 itself. An Ad Supplier 102, on the other hand, may itself be a Data Aggregator 104 and may even be an Ad Consumer 110 itself.

As illustrated in FIGS. 6A and 6B, application modules 401, being an internal part of a combined entity of an Ad Supplier 102 and a Data Aggregator 104, is programmed and configured to acquire information and/or image data relating to a local business either by directly accessing a data store 602 where local business data is stored, or by communicating with (e.g., using proprietary protocols), or calling, one or more an internal data engine module 603 (which may comprise one or more middleware or server programs) which have direct access to data store 602.

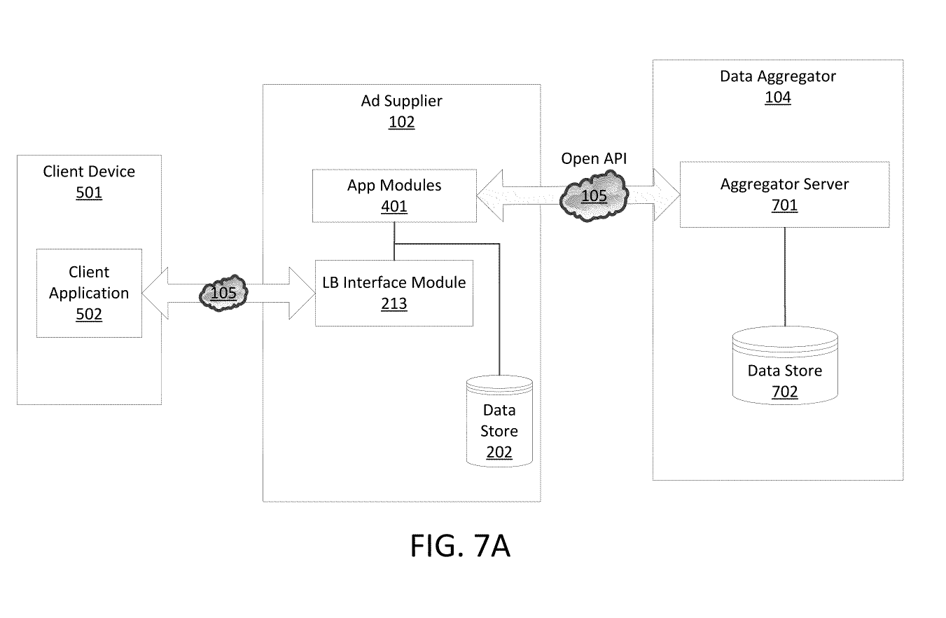

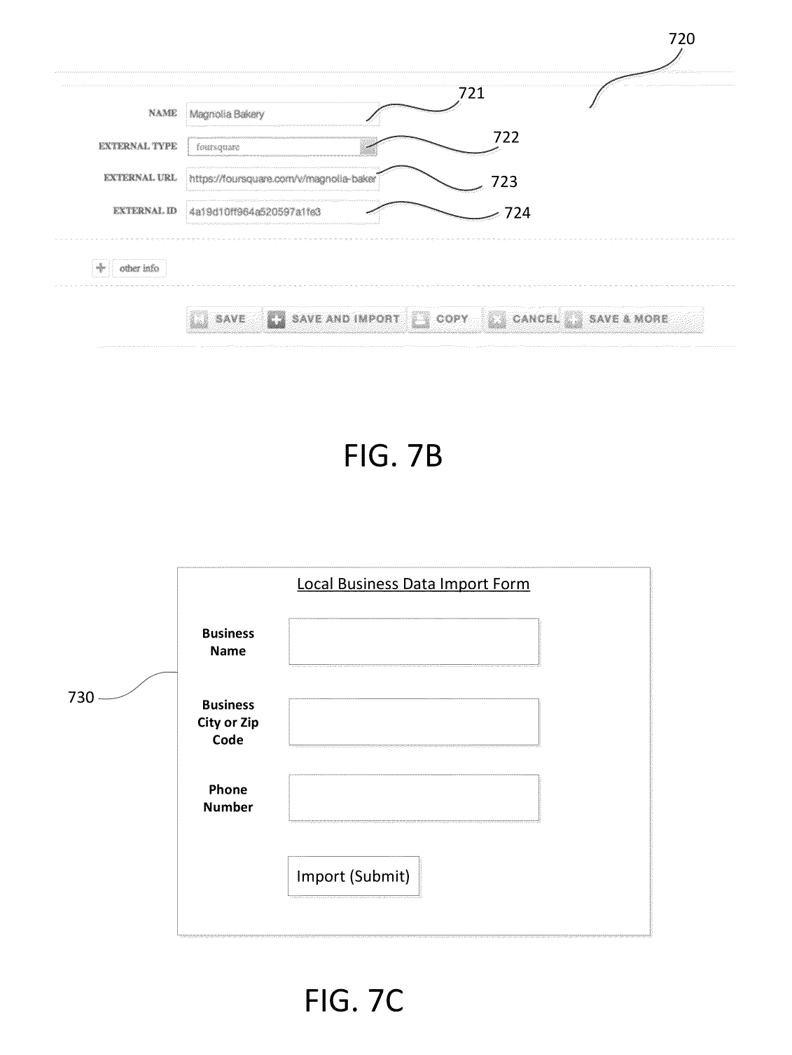

FIGS. 7A-C collectively illustrate a third type of local business ad data acquisition scheme as performed by one or more application modules 401 of Ad Creator 211, according to one or more embodiments of the present disclosure. As to this type of ad data acquisition scheme, referring to FIG. 7A which is a block diagram illustrating the third type of ad data acquisition scheme, one or more Data Aggregators 104 reside in a domain external to the domain of an Ad Supplier 102.

As illustrated in FIG. 7A, one or more application modules 401 are connected to a shown Data Aggregator 104 through, e.g., one or more communication networks 105. In particular, application modules 401 are configured and programmed to use, e.g., open application programming interfaces (APIs) provided by the Data Aggregator 104, to acquire local business ad data (namely, information and/or image data relating to a local business) stored in data store 702 of the Data Aggregator 104 via an aggregator server program 701 thereof. Specifically, Data Aggregators 104, such as Yelp and Four Square, often provide their respective open APIs that allow a third party to programmatically acquire information and/or image data about a local business which has pre-registered therewith.

As also illustrated in FIG. 7A, a local business may use a client device 501 to provide an initial set of link information to Ad Supplier 102 through client application 502. After receiving the initial set of link information of the local business (via, e.g., a local business interface module 213), Ad Supplier 102 may invoke application modules 401 to use the received initial set of link information to call respective open APIs of one or more Data Aggregators 104 so as to acquire local business ad data therefrom. As to the third type of ad data acquisition scheme, unlike the first type of ad data acquisition scheme disclosed in FIGS. 5A-5C (where application modules 401 acquire local business ad data through the uploading by the local business), application modules 401 instead acquire local business ad data from one or more external Data Aggregators 104. In doing so, the local business only needs to supply the initial set of link information, which is usually minimal), so long as the initial set of link information provides adequate input data which enables application modules 401 to call open APIs of one or more Data Aggregators 104 so as to get target local business ad data therefrom.

Referring to FIG. 7B, which is a pictorial illustrating an exemplary UI 720 through which the local business can provide an initial set of link information, the initial set of link information as needed from the local business, in one implementation, includes, e.g. identity information 721 of the local business (e.g., name of the local business), the respective one or more names 722 of one or more Data Aggregators 104, the respective identification information of the local business 724 assigned by the one or more Data Aggregators 104, and/or respective URL information 724 of the Data Aggregators 104.

Referring to FIG. 7C, which is a pictorial illustrating another exemplary UI form 730 through which the local business can provide the aforementioned initial set of link information. The initial set of link information as needed from the local business, in one implementation, only includes the name of the local business, the city or zip code of the local business, and the business phone number of the local business. As a skilled artisan appreciates, compared to submission form 511 for the first type of ad data acquisition scheme, UI form 730 is simpler, and may even be a lot simpler. For example, submission form 511 may include an input field that prompts the local business to enter the full address thereof. By contrast, UI form 730 may only include an input field that prompts the local business to enter either city or zip code thereof. Moreover, submission form 511 may further include UI elements adapted to let the local business to upload an image thereof. By contrast, UI form 730 may not need to include similar UI elements for uploading an image of the local business.

In one implementation, as to both the second and third types of ad data acquisition schemes, UI form 520 (illustrated in FIG. 5C) may always be used to let the local business to submit, e.g., one or more promotional messages for inclusion in one or more banner ads or display ads to be created therefor.

As a skilled artisan appreciates, there can be various ways in which Ad Supplier 102 can cause application modules 401 to be invoked. As one example, local business interface module 213, upon receiving the initial set of link information, may directly call application modules 401 with the link information provided as input data thereto. As another example, local business interface module 213, upon receiving the initial set of link information, may first store the link information in data store 202. Later, a regularly scheduled cron or batch job (not shown), upon detecting from data store 202 the newly received link information for the local business, may retrieve the link information from the data store, and then invoke application modules 401 with the link information provided as input data thereto.

As a skilled artisan also appreciates, the ad data acquisition schemes disclosed above, regardless of type, are fundamentally distinct from the conventional “searching and filtering” ad data acquisition scheme disclosed in the '496 application. As discussed above, the latter (namely, conventional “searching and filtering” scheme) cannot avoid non-trivial human effort to confirm or filter search results for contents relating to a target local business. This is because the latter is not disclosed as searching against various external databases through using proven reliable data acquisition means, such as calling open APIs provided by the respective various external databases. By contrast, the ad data acquisition schemes of the present disclosure invariably use proven reliable data acquisition means—such as calling open APIs of Data Aggregators, accessing internal databases, or directly receiving data from the local business itself—to acquire ad data, and thus either does not require confirmation or filtering as otherwise required by the conventional ad data acquisition schemes, or only requires very minimum human confirmation or filtering efforts. This in turn results in the disclosed ad creation system and method either avoiding human time and effort for data confirmation or data filtering altogether, or only requiring insubstantial and minimal human time and effort expended to ensure that acquired ad data is applicable and related to the local business.

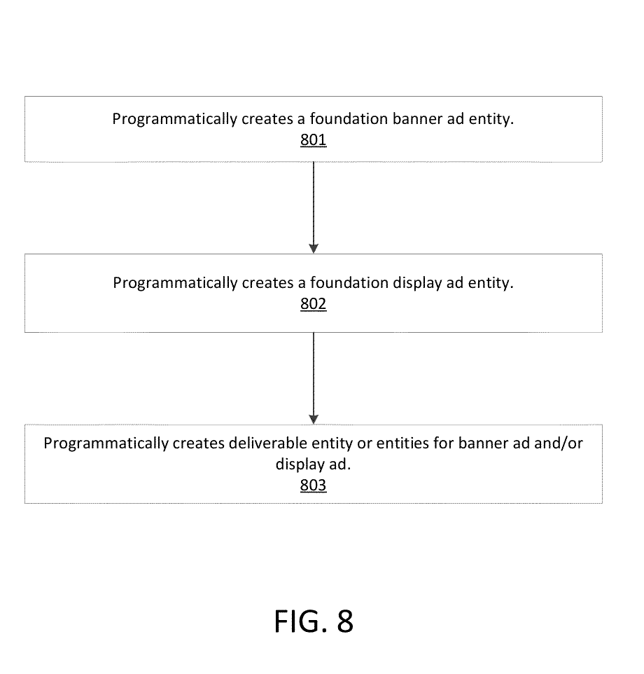

FIG. 8 is a flowchart illustrating an exemplary implementation of block 402—namely, programmatically creating a banner ad and/or a display ad for a local business—according to one or more embodiments of the present disclosure. Referring to FIG. 8, blocks 801, 802 and 803 are sub-blocks of block 402. Blocks 801, 802 and 803 may be performed without regard to any particular order, at different periods of time, on different computing machines, or in different domains. For example, some sub-blocks of block 803 implementing a deliverable entity for the banner ad may be performed after some sub-blocks of block 802 are performed. As another example, blocks 801 and 802 may be performed immediately following the completion of block 401 in the same contemporaneous period of time, while block 803 may be performed hours, days or even months thereafter when an actual request for supplying mobile advertisements (for local businesses) arrive. As yet another example, block 803 may be performed in a domain different from the one where block 801 is performed. Further, as will be provided in more detail below, blocks 801 and 802 may not need to be performed separately under some circumstances. Thus, both blocks 801 and 802 are optional blocks under some particular circumstances.

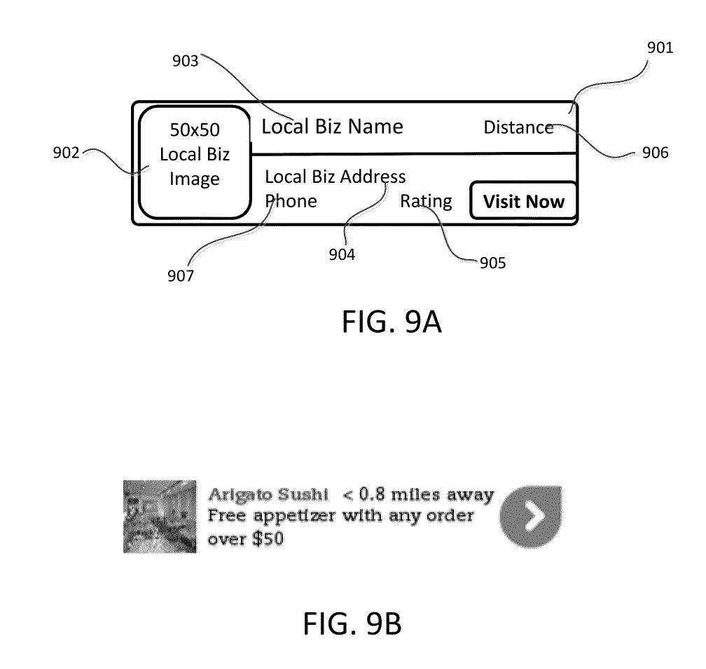

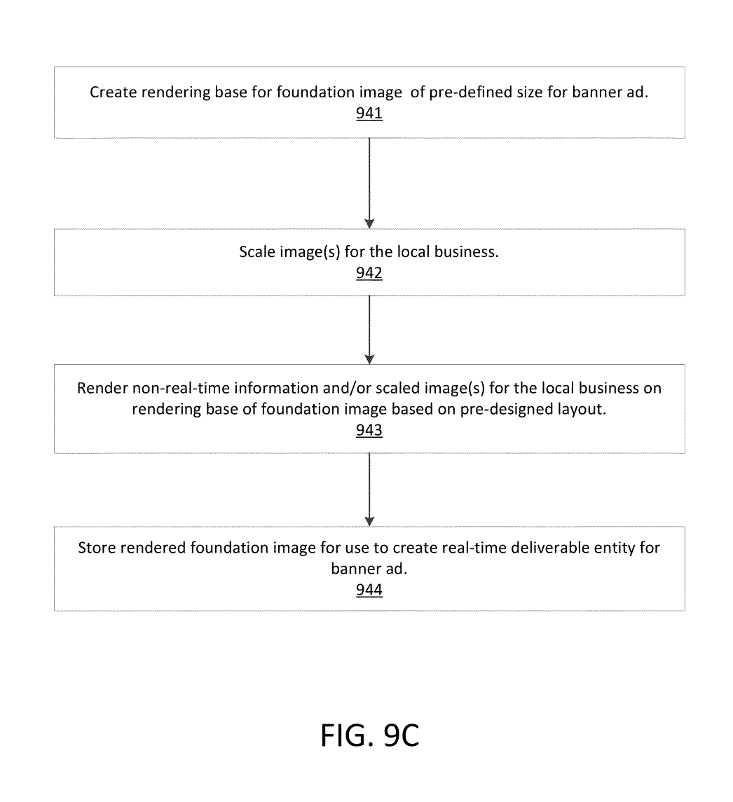

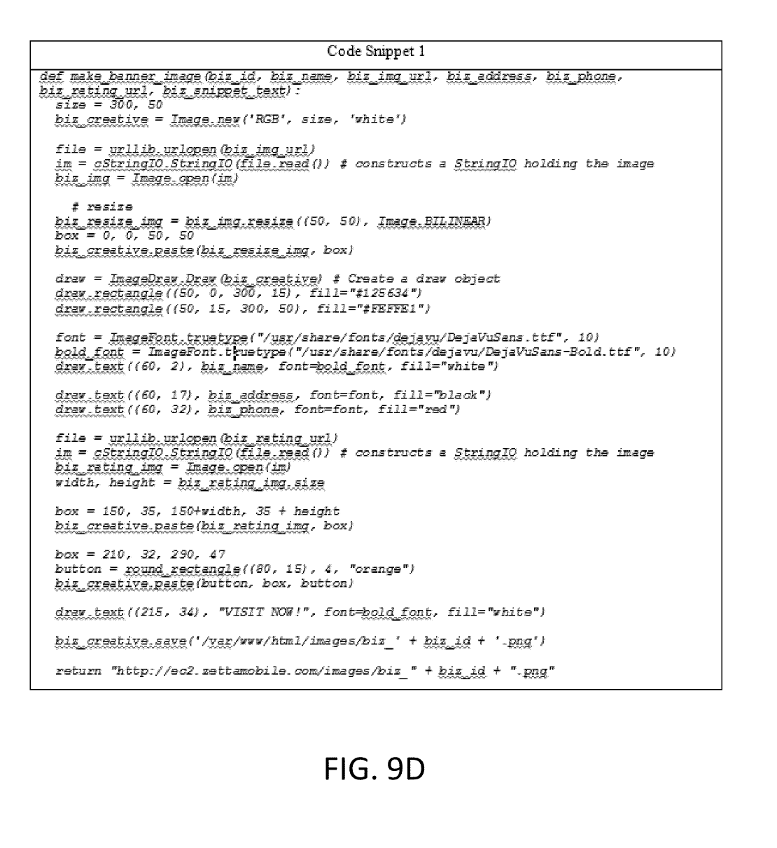

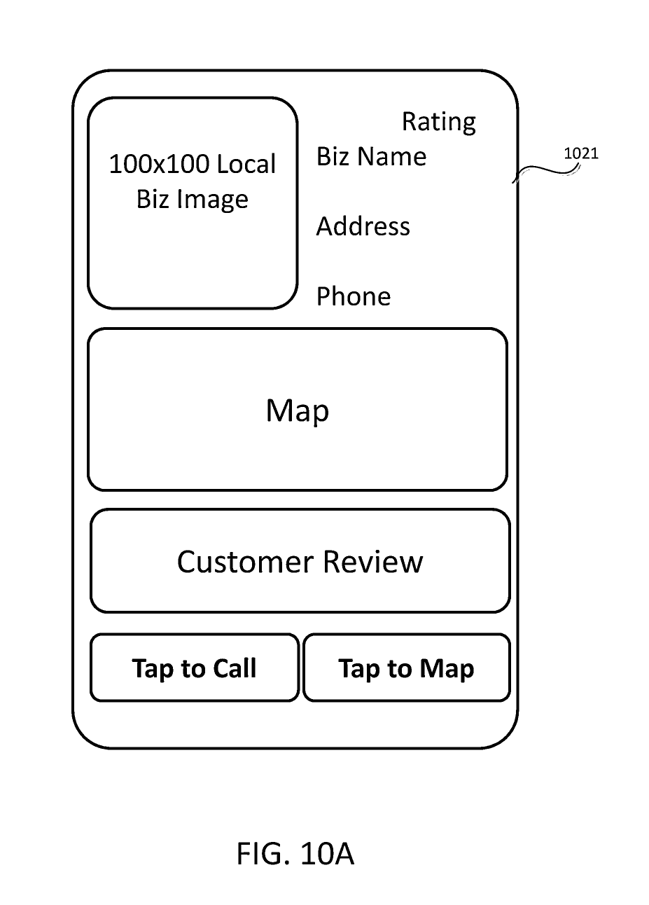

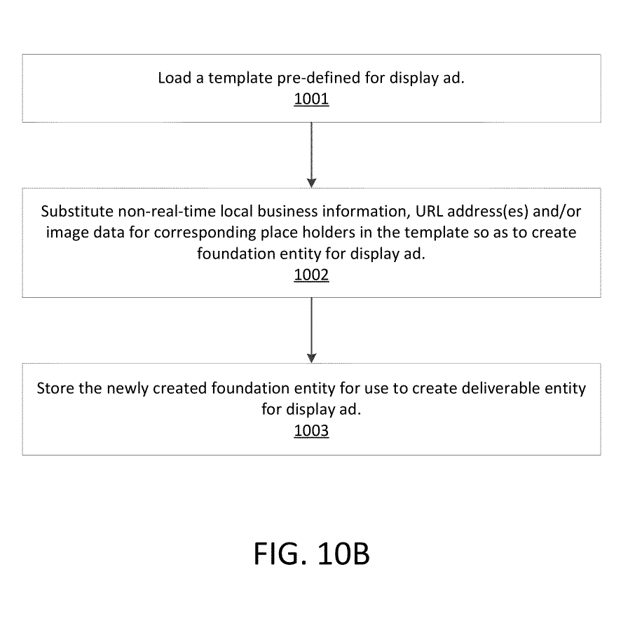

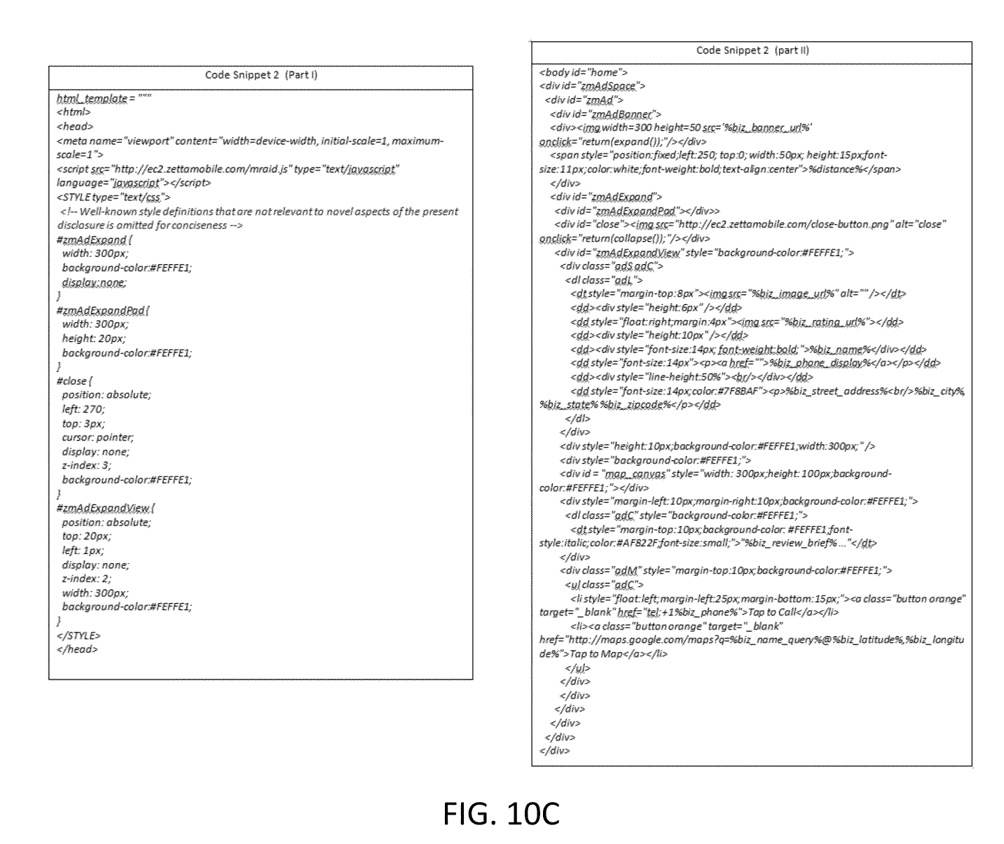

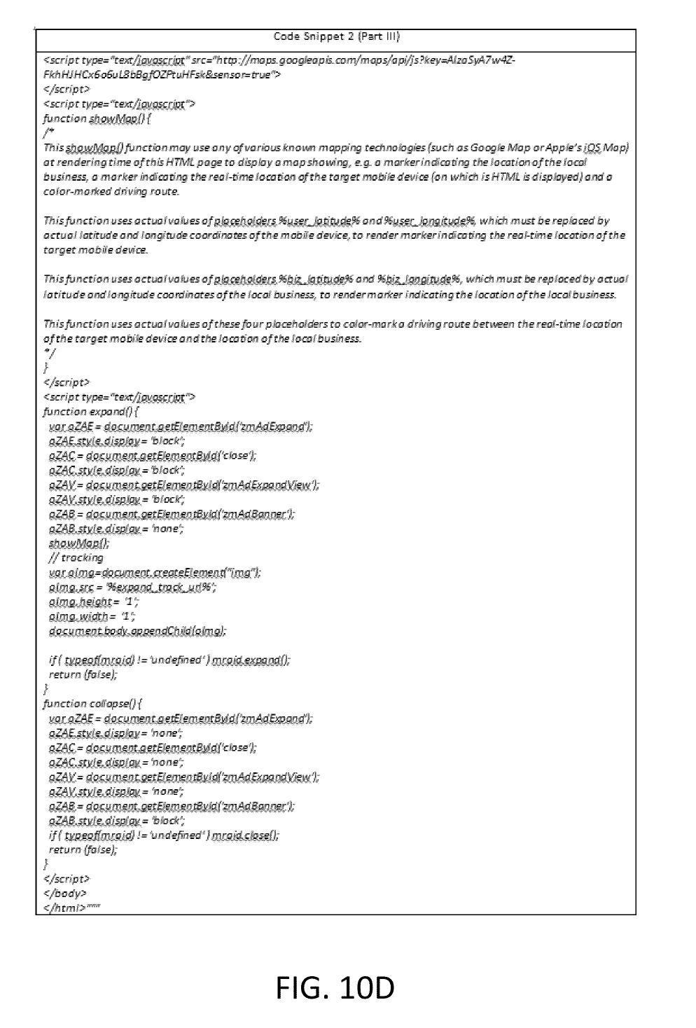

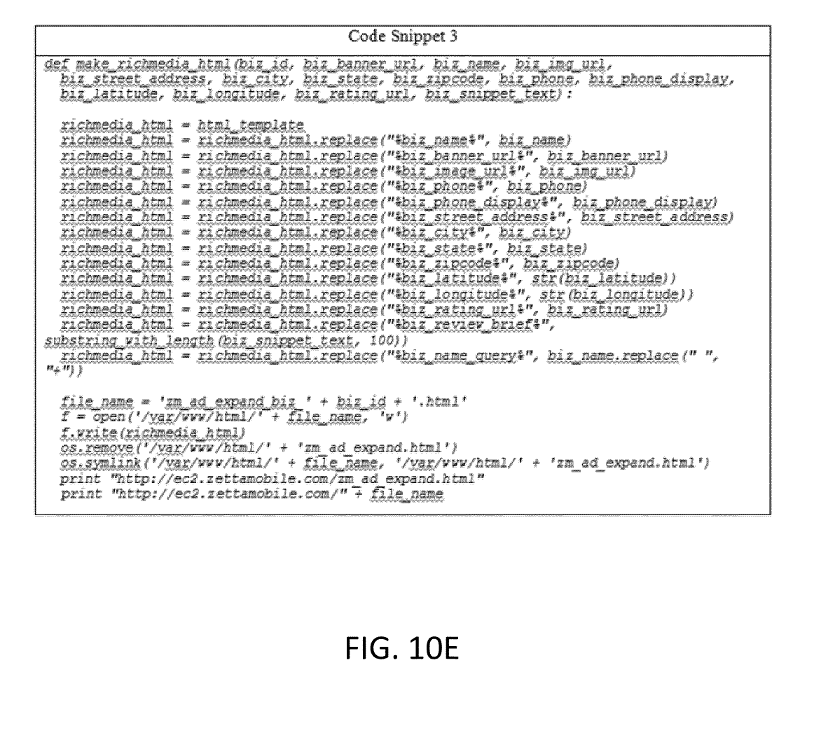

At block 801, a foundation entity for the banner ad for the local business is programmatically created, as will be further disclosed in detail below with reference to FIGS. 9A-D. At block 802, a foundation entity for the display ad is programmatically created, as will be further disclosed in detail below with reference to FIGS. 10A-E. Foundation entities created in blocks 801 and 802 may be stored for use by block 803. At block 803, one or more deliverable entities for the banner ad and/or the display ad are programmatically created so that the banner ad and/or the display ad can be displayed for mobile advertising. The deliverable entities may be created at real-time based on foundation entities created at blocks 801 and 802.

FIGS. 9A-D illustrate an exemplary implementation of block 801 (namely, programmatically creating a foundation entity for the banner ad), according to one or more embodiments of the present disclosure.

FIG. 9A shows, for the purpose of illustration and not limitation, a visual depiction of an exemplary layout 901 pre-defined for creating a foundation image for the banner ad. In particular, layout 901 is one designed as corresponding to banner ad 301 illustrated in FIG. 3A. In this embodiment, the layout is of a fixed size, which may be a standard size defined for a banner ad for mobile advertising. As a skilled artisan appreciates, a layout can be implicitly defined by an actual implementation of the foundation image without being reduced to a concrete form, such as a definition file (containing a description of the layout) or a layout image (pictorially defining a layout).

Referring to FIG. 9A, the layout for the banner ad defines or sets out, within the boundaries of a rectangle defined by the layout's fixed size (referred to hereinafter as “the layout rectangle”), physical areas for displaying a plurality of text or image fields for the local business. As depicted, an image for the local business is allocated to be displayed in a 50×50 area 902 on the far left of the layout rectangle. Similarly, a name of the local business 903 is allocated to be displayed in an area to the right of the image area above an imaginary horizontal divider line. Other sections in the layout, namely, sections 907, 904, 905 and 906, correspond to phone information 307, address information 304, rating information 305 and real-time distance information 306, respectively.

Optionally, for text fields, same or different fonts, sizes or colors may be used for rendering text. Also optionally, aesthetic decorations, such as round corners, may be applied to the borders of the layout rectangle. Thus, in addition to the layout, font, size or color specifications or decoration specifications may also be part of an overall design pre-defined for a banner ad (referred to hereinafter as “banner ad design”). When parts or all of the text and/or image fields are rendered at their respective locations to the extent that a user of a target mobile device is adequately apprised with regard to the local business, a foundation image for the banner ad is created according to the pre-defined layout.

As a skilled artisan readily appreciates, there can be myriad different layouts for a banner ad without departing from the scope and spirit of the present disclosure. For example, referring to FIG. 9B, which is a pictorial illustrating a banner ad created using a different layout, the areas (in the layout otherwise illustrated in FIG. 9A) which are marked for address, phone and rating, may be used for displaying a promotional message (which, e.g., may be provided by the local business through UI form 520 or an e-mail sent from the local business regarding same) about one or more deals, offers, or promotions designed to attract the user's attention and stimulate the user's interest to patronize the local business.

The flowchart shown in FIG. 9C, along with a simplified code snippet 1 provided in FIG. 9D, illustrates exemplary blocks employed to create a foundation image for the banner ad according to the layout visually depicted in FIG. 9A. In particular, block 801 is a sub-block of block 402, which, as noted above in connection with block 402, has access to the local business ad data acquired at block 401. Also, the acquired ad data may include, but are not limited to, a URL where an image of the local business can be downloaded, a name of the local business, an address thereof, a phone number thereof, and up-to-date customer feedback information (which may include an overall rating) thereon.

At block 941, a rendering base (which may be defined in the form of an image object) of a pre-defined size (which, in this case, is 300×50 in, e.g. unit of pixel) for the foundation image is programmatically created. As provided in code snippet 1, an image of the local business can be acquired by downloading the image from a URL received at block 401. At block 942, the acquired image of the local business is scaled to 50×50 according to the image size requirement set forth in the pre-defined layout. At block 943, the scaled image of the local business and other non-real-time information of the local business—such as, the name of the local business, the address thereof, the phone number thereof, and/or the overall customer rating for the local business—are rendered at their respective allocated areas on the rendering base according to the pre-defined layout.

Notably, information that is only available at real time (such as the distance from the target mobile device to the location of the local business) may not be available when the foundation image is rendered in substantial advance of the contemporaneous time period of the actual delivery of the banner ad. Thus, no real-time information is rendered on the found image for the banner ad when the foundation image is created in substantial advance of the actual delivery time of the banner ad.

Optionally, text fields may be rendered according to font, size and color specifications pre-defined as part of the banner ad design. Also optionally, decorations, such as rounded corners, may be rendered according to a decoration specification pre-defined as part of the banner ad design. A foundation image is created after the rendering of the foundation image is completed. At block 944, the created foundation image may be temporally or permanently stored for use to create an eventual deliverable entity for the banner ad at block 803.

The created foundation image for the banner ad can be a form of the foundation entity for the banner ad referred in block 801. As a skilled artisan appreciates, there can be other forms of the foundation entity referred in block 801. As one example, an renderable markup file—such as an HTML file adapted to display the created foundation image by, e.g., defining an area for rendering the created foundation image and referencing an URL from which the foundation image (created and stored using blocks 941-944) can be downloaded—may be another form of the foundation entity referred to in block 801. As another example, an HTML file—which is specifically authored using HTML tags to implement the pre-defined layout and render a foundation image (similar to the foundation image created) based on the layout without using or referencing the foundation image (created and stored using blocks 941-944)—may be yet another form of the foundation entity referred to in block 801.

As demonstrated, a foundation entity for the banner ad, such as a foundation image for the banner ad, is a renderable entity, which, when rendered, displays information and/or image data pre-collected for the banner ad except information and/or image data that can only be collected, calculated or rendered at real time (referred to hereinafter as “real-time information”). Thus, a foundation entity for the banner ad is created to facilitate and expedite the creation of a deliverable entity for the banner ad at block 803. More specifically, if the deliverable entity for the banner ad is decided to reflect real-time information by, e.g., displaying real-time information in addition to non-real-time information, then the deliverable entity for the banner ad can be created by incorporating the needed real-time information (such as the distance between the target mobile device and the location of the local business) into the foundation entity (as will be exemplified below). On the other hand, if the deliverable banner ad is decided not to reflect any real-time information, the foundation entity for the banner ad that have already been created and stored at block 801 may then be directly used as the deliverable entity for the banner ad at block 803.

In the implementations illustrated in FIGS. 9A-D, the pre-defined layout used to create a foundation entity for the banner ad is of a particular pre-set size. If a different new size is required for the banner ad, then a different new layout may be defined for the new foundation entity to optimize the presentation of information and image(s) for the local business. Alternatively, a pre-stored foundation image may be scaled to the new size for use to form the new foundation entity for the banner ad.

FIGS. 10A-E illustrate an exemplary implementation of block 802 (namely, programmatically creating a foundation entity for the display ad) according to one or more embodiments of the present disclosure.

In this embodiment, a pre-defined HTML template is used to create a foundation entity for the display ad. For illustration and not limitation, an example of the pre-defined HTML template is provided in a simplified code snippet 2 illustrated in FIGS. 10C and 10D. As noted above in connection with FIG. 3B, the display ad is designed to provide detailed information with regard to the local business, as the display ad is expected to occupy most or all of the screen space otherwise occupied by the main content and the banner ad. Since different mobile devices may have drastically different screen sizes, the display ad may be created to adapt to and take advantage of whatever size of the screen space that a target mobile device can provide. As a skilled artisan appreciates, HTML is markup language designed to render content in a manner adaptive to the size of a target screen space. Thus, in this embodiment, the pre-defined template for the display ad is chosen to be created in HTML, so that information and images (e.g. the map image) for the local business can be optimally rendered in a manner adaptive to the size of a target mobile display screen. In the same token, as a skilled artisan appreciates, other markup languages, other rendering means, or any combination thereof, can likewise be used to define a template for a foundation entity for the display ad, as long as they can be used to render information and images in a manner adaptive to the size of a provided screen size.

The pre-defined HTML template, in its original form, contains a set of typically unrenderable placeholders designed to be replaced by renderable corresponding actual information, URL address(es), or image(s). Thus, the template, in and by itself, is typically not renderable. FIG. 10A, for the purpose of illustration and not limitation, visually depicts an exemplary layout 1021 intended by the pre-defined HTML template for the display ad 321 illustrated in FIG. 3B, as the depicted layout shows the relative locations of different fields within an eventually rendered display ad.

FIG. 10B, along with a simplified code snippet 3 provided in FIG. 10E, illustrates exemplary blocks taken to create a foundation entity for the display ad based on a pre-defined HTML exemplified by code snippet 2. At block 1001, a predefined HTML template, such as the one exemplified in code snippet 2, is loaded into, e.g., a programmatic string or a file.

At block 1002, placeholders (in the template) holding places for non-real-time information, are replaced by corresponding actual local business information, one or more URL addresses, or image data that have already been acquired or generated in blocks that have taken place earlier (such as block 401 or block 801 if block 401 or block 801 has taken place before block 1002). For example, as provided in code snippet 3, placeholder “% biz_image_url” is replaced by an actual URL from which an image for the local business can be downloaded. The actual URL may be one provided by a third-party Data Aggregator 104 to Ad Creator 211 according to the embodiment shown in FIG. 7A. Alternatively, the actual URL may correspond to a file location where, as noted above in connection with block 401, an image for the local business is temporally or permanently stored as part of block 401. If the corresponding actual information for a non-real-time placeholder is not available, then renderable default data (e.g. an error text indicating that actual corresponding information is not available) may be used to replace the placeholder. The foundation entity is created in the form of an HTML file after the non-real-time placeholders are replaced accordingly.

At block 1003, the newly created foundation entity is stored for use to create a deliverable entity for the display ad at block 803. If the display ad is to display certain real-time information (such as a visual marker 326A on map 329 indicating the real-time location of the target mobile device, as illustrated in FIG. 3B), then the pre-defined template may contain placeholders for certain real-time information (such as the real-time latitude and longitude coordinates of the target mobile device 101) only available at the time of actual delivery of the display ad. Thus, if the foundation entity for the display ad is created in substantial advance of the actual delivery of the display ad, those real-time placeholders may remain in the foundation entity. A deliverable entity for the display ad may later be created at the actual delivery time by incorporating received actual real-time information into the foundation entity created at block 1002 through replacements of those remaining real-time placeholders by the received corresponding actual real-time information.

As an example, a deliverable entity for the display ad may be created by replacing the “% user_latitude %” and “% user_longitude %” placeholders in the foundation entity by received actual real-time latitude and longitude coordinates of the target mobile device (which may be provided by a Content Provider requesting for supplying of mobile advertisements). As a result, the deliverable entity for the display ad (which is the resulting HTML file), when rendered, causes the display ad to display a mark 326A on the map indicating the real-time geographical location of the target mobile device and/or a color-marked driving route 326B from the location of the target mobile device to the location of the local business, thereby giving the user a clear visual impression as to the location of the target mobile device relative to the location of the local business.

On the other hand, if a deliverable banner ad is decided not to include or otherwise reflect any real-time information, then the foundation entity created and stored at blocks 1001-1003 can be directly used as the delivery entity for the banner ad (after all placeholders are resolved in ways indicated above). The HTML file (for the display ad) created using the pre-defined HTML template provided in code snippet 2, in fact, can serve as one unified foundation entity for both the banner ad and the display ad. Specifically, the pre-defined HTML template contains a placeholder “% biz_banner_url %”, which is designed to be replaced by a URL (referred to hereinafter as “banner ad image URL”) from which a foundation image created for the banner ad (e.g. created and stored at blocks 941-944) can be downloaded. The pre-defined HTML template is authored in such a way that when a resulting HTML file is rendered for display, what is initially displayed is only the banner ad in the form of the downloaded foundation image. The display ad is only displayed, as illustrated in FIG. 3B, when the initially displayed banner ad is clicked or tapped. Thus, at block 1002, when the foundation image for the banner ad created at block 943 is stored at block 944 as a file in a location mapped to a URL, the mapped URL becomes the banner ad image URL when the mapped URL substitutes for the “% biz_banner_url %” placeholder in the pre-defined HTML template. The resulting HTML file can thus serve dual purposes of being a foundation entity for the display ad and being a foundation entity for the banner ad.

A skilled artisan appreciates advantages provided by the aforementioned unified foundation entity for both the banner ad and the display ad, a foundation entity which advantageously serves the dual purposes of being a foundation entity for the display ad and being a foundation entity for the banner ad. Specifically, with the unified foundation entity, a unified deliverable entity for both the banner ad and the display ad can be readily created (as will be illustrated below). Without the unified deliverable entity for delivering and rendering both the banner ad and the display ad, Ad Supplier 102 would have needed to transmit at least two separate deliverable entities (namely, a first deliverable entity for the banner ad and a different second deliverable entity for the display ad) to an Ad Consumer 110 using two separate transmissions (if the user of the target mobile device 101 ends up tapping the earlier delivered banner ad). In contrast, with the unified deliverable entity, Ad Supplier 102 only needs to use one single transmission to deliver both the banner ad and the display ad, thereby conserving usually valuable communication bandwidth resources and increasing its transmission efficiency.

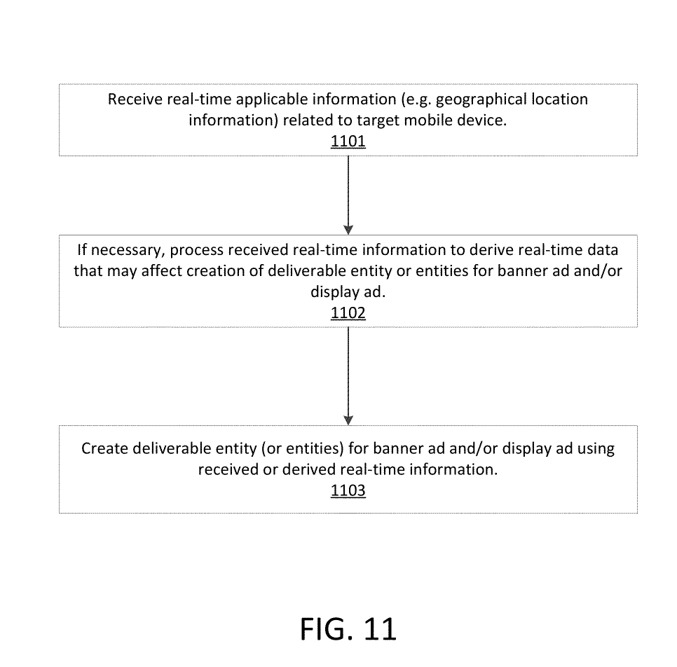

FIG. 11 is a flowchart illustrating an exemplary implementation of block 803 (namely, programmatically creating deliverable entity or entities for the banner ad and/or the display ad) according to one or more embodiments of the present disclosure. As used herein, a deliverable entity refers to an entity which, when delivered to an Ad Consumer 110 such as a Content Provider, can be rendered by the Ad Consumer for mobile display based on the content contained therein. A fully-compliant HTML file or string (e.g. without any outstanding unresolved placeholder) or equivalent one or more data packets thereof, and an image file or equivalent one or more data packets thereof, are examples of a deliverable entity in the context of the present disclosure.

At block 1101, real-time information related to a location-aware target mobile device 101 that is applicable to the creation of the banner ad and/or the display ad for the local business, such as the latitude and longitude coordinates of the target mobile device, is programmatically received.

At block 1102, if needed, the received real-time information is programmatically processed so as to derive real-time data that may affect the creation of the banner ad and/or the display ad. For example, the received the latitude and longitude coordinates of the target mobile device may be processed to calculate the real-time distance between the target mobile device and the address (location) of the local business. The calculated real-time distance will then be rendered and/or overlaid on the banner ad, as illustrated and exemplified in code snippet 2.

At block 1103, one or more deliverable entities for the banner ad and/or the display ad are programmatically created using real-time information received at block 1101 and/or real-time data derived at block 1102.

In one exemplary implementation of block 1103, a deliverable entity for both the banner ad and the display ad can be created by incorporating real-time information received at block 1101 and/or real-time data derived at block 1102 into the foundation entity (which, as noted above in connection with code snippet 2, is an HTML file) created at blocks 1001-1003 based on the pre-defined HTML template exemplified by code snippet 2. Specifically, as noted above in connection with FIG. 10B and code snippet 2, the foundation entity so created can serve as a foundation entity for both the banner ad and the display ad. Thus, when the foundation entity (the HTML file) is modified—by, e.g., replacing the % distance % placeholder by the real-time distance between the target mobile device and the location of the local business derived at block 802 as well as replacing the “% user_latitude %” and “% user_longitude %” placeholders in the foundation entity by the actual real-time latitude and longitude coordinates of the target mobile device received at block 1101—the resulting HTML file becomes a single deliverable entity for both the banner ad and the display ad.

In another exemplary implementation of block 1103, separate deliverable entities may be created for the banner ad and the display ad, using, e.g. foundation entities separately created at blocks 801 and 802, respectively, by incorporating received or derived real-time information into the respective foundation entities.

In yet another exemplary implementation of block 1103, at least one deliverable entity may be created without using a pre-created foundation entity. For example, the deliverable entity for the banner ad can be created from scratch (using the information or image data received at block 401) by directly incorporating substantive blocks otherwise performed during blocks 941-943. Thus, block 801, which, as noted above in connection with FIG. 8, is optional, may not be needed. In the same token, the deliverable entity for the display ad may also be created from scratch (using the information or image data received at block 401) by directly incorporating substantive blocks otherwise performed during blocks 1001-1002. Thus, block 802, which, as noted above in connection with FIG. 8, is optional, may not be needed as well.

In yet another exemplary implementation of block 1103, only a deliverable entity for the banner ad is created. The created deliverable entity, when rendered as the banner ad, causes the clicking or tapping of the banner ad to result in the target mobile device displaying things other than a display ad. For example, in this implementation, the clicking or tapping of the displayed banner ad may result in the target mobile device visiting an official web site of the local business.

As a skilled artisan appreciates, there can be various types of real-time information (related to the target mobile device) that are applicable to the creation of a banner ad and/or a display ad for the local business. For example, demographic information about the user owning the target mobile device can be applicable real-time information related to the target mobile device (as referred to in block 1101) that may affect the creation of the banner ad or the display ad.

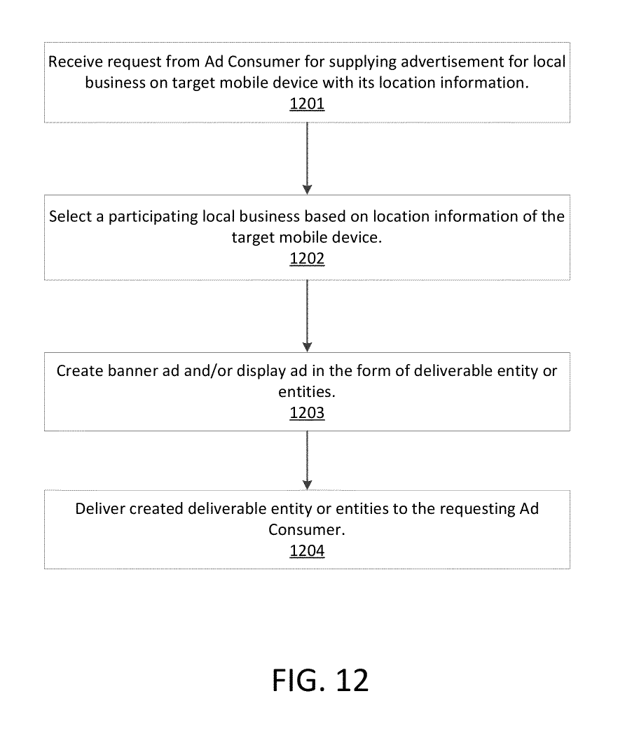

FIG. 12 a flowchart illustrating a method that an Ad Supplier 102 (incorporating the system and method illustrated in FIGS. 3-11) uses to supply mobile advertisements for local businesses according to one or more embodiments of the present disclosure.

At block 1201, Ad Supplier 102 receives from an Ad Consumer 110 a request for supplying a local business advertisement for display on a target mobile device 101 with the target mobile device's real-time location information. The request may include real-time information related to the target mobile device, such as the real-time latitude and longitude coordinates of the target mobile device. As a skilled artisan appreciates, the Ad Supplier and the Ad Consumer do not have to be in different domains. In fact, the Ad Supplier and the Ad Consumer may be in the same domain.

At block 1202, the Ad Supplier selects a participating local business (local to the location of the target mobile device) based on received real-time information including the target mobile device's real-time location information, such as the real-time latitude and longitude coordinates thereof.

At block 1203, the Ad Supplier 102 creates one or more deliverable entities for a banner ad and/or a display ad for the selected local business by using the advertisement creation system and method illustrated in FIGS. 3-11. In particular, since block 1203 is carried out during a time period of an actual delivery of the banner ad and/or the display ad, block 1203 may only need to use blocks 1101-1103 to realize the creation of the banner ad and/or display ad.

At block 1204, the Ad Supplier delivers the one or more deliverable entities for the banner ad and/or the display ad created at block 1203 to the requesting Ad Consumer.

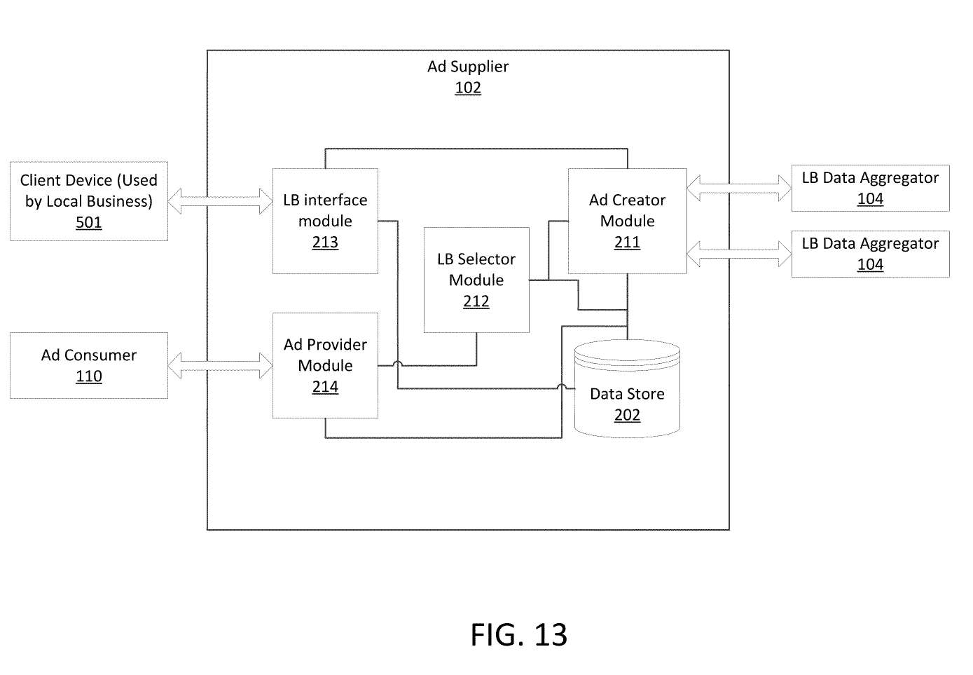

FIG. 13 is a block diagram illustrating an Ad Supplier system 102 configured to supply mobile advertisements for local businesses to a location-aware target mobile device 101, according to one or more embodiments of the present disclosure.

As illustrated, the Ad Supplier system comprises functional modules (which may be software, hardware, or any combination thereof) including local business interface module 213, Ad Creator module 211, a local business selector module 212, data store 202 and an ad provider module 214. As exemplified in FIG. 7A, local business interface module 213 may be used to interface with a local business via a GUI exemplified in FIG. 7B or 7C, and subsequently uses Ad Creator 211 (whose components and functions have been illustrated in FIGS. 3-11) to receive and store (in data store 202) information and/or image data for the local business from one or more Data Aggregators 104. Thus, Ad Supplier system 102 may interface with (or register) local businesses that have already been affiliated with different Data Aggregators 104 for the purpose of programmatically creating mobile advertisements and supplying programmatically created mobile advertisements for the local businesses. Local business interface module 213 may also be used to interface participating local businesses via a submission form 511 exemplified in FIG. 5B, and store the received information and/or image data for the local business in data store 202 for the advertisement creation and supplying purposes.

The ad provider module 214 is programmed and configured to receive requests from an Ad Consumer 110 for supplying a local business advertisement, and deliver to the Ad Consumer 110 a banner ad and/or a display ad subsequently created by Ad Creator 211. As noted above, the Ad Consumer 110 may be in the same domain as the one which the Ad Supplier 102 is in. Specifically, upon receiving a request for supplying a local business advertisement (referred to hereinafter as “ad-supply request”) for a location-aware target mobile device, the ad provider module 214 may call, or otherwise communicates with, the local business selector module 212 with regard to the ad-supply request, such that the local business selector module 212 selects a participating (e.g., signed-up) local business in close proximity to the target mobile device as the local business for which an advertisement will be supplied for display on the target mobile device. The selection of a qualifying local business may be based on random scheme or based on a priority queue established in accordance with payment situations in connection with participating local businesses.

Next, the local business selector module 212 calls or communicates with Ad Creator 211 with regard to creating a banner ad and/or a display ad for the selected local business. Ad Creator 211 subsequently creates one or more deliverable entities for the banner ad and/or the display ad, as illustrated in FIGS. 3-11. The created one or more deliverable entities will then be provided to the ad provider module 214, which delivers the one or more deliverable entities to the requesting Ad Consumer 110.

The Ad Supplier System 102 may further include an accounting module (not shown), which is adapted to bill participating local businesses for services of providing location-aware mobile advertising services thereto.

Accordingly, with the novel and innovative systems and methods illustrated in FIGS. 1-13, the major bottleneck described above with respect to meeting the increasing demand for supplies of paid local business advertisements for display on location-aware mobile devices—namely, conventional online advertising systems do not have available an effective solution which makes it substantially hassle-free for local small businesses to create their own advertisements specifically suitable and effective for being placed on location-aware hand-held mobile devices as respective users of the mobile devices are accessing various contents provided by Content Providers—may be effectively addressed or relieved, so that the increasing demand for supplies of paid local business advertisements can be met.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

Therefore, it is intended that the disclosure not be limited to the particular embodiments disclosed for carrying out this disclosure, but that the disclosure will include all embodiments falling within the scope of the appended claims.

What is claimed is:

1. A system of programmatically creating advertisements effective and suitable for display on a small display screen of a mobile device, the system comprising:
means for programmatically acquiring advertisement data of a local business;
means for receiving real-time location information of the mobile device;
means for programmatically creating a banner ad based on the acquired advertisement data and the received real-time location information of the mobile device; and
wherein the created banner ad displays information identifying the local business as well as information indicating location of the local business relative to the real-time location information of the mobile device.

2. The system of claim 1, further comprising:
means for programmatically creating a display ad based on the acquired advertisement and the received real-time location information of the mobile device.

3. The system of claim 1, wherein the means for programmatically acquiring the advertisement data further comprises:
means of acquiring the advertisement data through accessing a third party data aggregator system via open APIs thereof.
